(19) United States
(12) Patent Application Publication
(10) Pub. No.: US 2025/0141270 A1
(43) Pub. Date: May 1, 2025

(54) SYSTEMS AND METHODS FOR DEPLOYABLE AND REUSABLE NETWORKS OF AUTONOMOUS VEHICLES

(71) Applicant: Metasat Inc., Kitchener (CA)

(72) Inventors: Haroon B. Oqab, Kitchener (CA); George B. Dietrich, Kitchener (CA); Nobuyuki Kaya, Kobe (JP)

(21) Appl. No.: 18/681,743

(22) PCT Filed: Aug. 8, 2022
(86) PCT No.: PCT/CA2022/051210

§ 371 Date: Feb. 6, 2024

Related U.S. Application Data
(60) Provisional application No. 63/230,391, filed on Aug. 6, 2021.

(51) Int. Cl. H02J 50/12; B64U 10/10; B64U 10/30; B64U 70/90

(52) U.S. Cl. CPC H02J 50/12; B64U 10/10; B64U 10/30; B64U 70/90

(57) ABSTRACT

Systems and methods for deployable and reusable autonomous vehicle systems and networks are provided. The autonomous vehicles include solar power satellite sandwich modules for collecting solar radiation and/or radiant heat and converting it to useable energy to power on-board systems, for storage, or for transmission as electromagnetic radiation in wireless power transfer. The autonomous vehicles disclosed herein may be configured as nodes in a fixed or mobile deployable network for wireless power distribution and/or data transmission across multiple domains (water/land-to-air-to-space). Fleets of autonomous vehicles may be configured for various applications such as micro- or macro-wireless power grids, beam riding highways for orbital raising, point-to-point-transport and in-flight charging, on Earth and in Space.

### TECHNICAL FIELD

The embodiments disclosed herein relate to deployable and reusable aircraft and spacecraft, and, in particular to systems and methods for deployable and reusable networks for power and data distribution across multiple domains.

### INTRODUCTION

Various classes of aircraft may possess different advantages and capabilities. For example, rotor-based aircraft, such as multirotor aircraft or helicopters, may allow for hovering and high maneuverability, while airships may allow for hovering with minimal energy expenditure. Coupling aircraft together may result in a combined aircraft with the combined benefits of each constituent aircraft. This may increase the number of possible use cases of each class of aircraft. However, aircraft range and flight time is ultimately limited by the amount of fuel they carry.

Similarly, certain aircraft may interact with ground-based objects. For example, aircraft may be used as aerial cranes or towing vehicles, for moving and lifting objects and/or removing unwanted objects. However, current methods of interfacing in-flight aircraft with ground-based objects are limited in capability and provide little flexibility and inter-vehicle operability.

In addition, communications with a satellite requires the focus of a narrow radio frequency beam, which need to be accurately pointed at the satellite for optimal functionality. Today, standard comms-on-the-move systems use a mechanical motorized gimbal to accomplish pointing, as a result these systems need more power to operate to maintain communications.

Sparsely populated areas are often underserved with limited power and communication services, and have limited access to digital infrastructure communities.

Dependence on fossil fuels is driving an environmental crisis by increasing concentrations of atmospheric greenhouse gases, which studies link to elevating average global temperatures and accelerating disruptive climate change. On the other hand, standards of living are directly correlated with per capita energy consumption, with the result that the desire to improve quality of life prompts consumption of higher and higher levels of energy per person. These circumstances, coupled with a continually growing population, consequently drive global energy requirements for clean renewable energy sources to be scaled up to meet demand while simultaneously replacing fossil fuels use for the largest energy needs including transportation and/or electrical power generation.

In-space powering and propulsion of space systems using existing, conventional fuels (including solid, liquid, and gas propellants) is costly and impractical for use and continuous operations over large distances or for long time periods given the weight/volume requirements and other challenges of storing fuel onboard, and additional logistical requirements. Transporting fuel to from Earth to orbit, and point to point travel in space, is also problematic given the high volatility of most conventional fuels and is further limited by size/weight requirements of spacecraft and/or launch vehicles. A further limitation is the range of a spacecraft is restricted by the amount of fuel carried onboard, and once fuel reserves are depleted, the spacecraft can no longer propel itself.

Accordingly, there is a need for new deployable and reusable mobile systems (aircraft, robots on land and water, and/or spacecraft), which can be configured as a network for communications and or wireless power transmission to support continuous operations, power beaming and or distribution systems and methods for coupling to and augmenting the propulsion and power generation across multiple domains.

### SUMMARY

Systems and methods for deployable and reusable autonomous vehicle systems and networks are provided.

According to an embodiment, there is an autonomous vehicle platform for relaying electromagnetic radiation, e.g., radio frequency signals. The autonomous vehicle platform comprises a hybrid propulsion system having at least one rotor/propeller and at least one inflatable balloon system. The autonomous vehicle platform includes a first antenna for transmitting electromagnetic radiation in one or more bands and a docking interface configured for docking with at least one other autonomous vehicle. The first antenna comprises an active phased array for digital beamforming of the one or more bands of electromagnetic radiation. The first antenna comprises an active 3D phased array.

The autonomous vehicle platform may include a second antenna for receiving the electromagnetic radiation in one or more bands. The first antenna and the second antenna may be part of a transceiver. The second antenna comprises an active phased array. The second antenna comprises an active 3D phased array.

The autonomous vehicle platform may include a deployable structure having at least one of the first antenna and the second antenna disposed thereon. The autonomous vehicle platform may include a deployable structure having the docking interface disposed thereon. The docking interface may include a magnetic and or an electromagnetic coupling.

The autonomous vehicle platform may comprise a plurality of rectennas on a surface of autonomous vehicle platform for receiving electromagnetic radiation in one or more bands. The surface may be on a deployable structure.

According to another embodiment, there is a solar power satellite sandwich module, comprising a first surface having a plurality of solar cells disposed thereon and a second surface having at least one of a transmitter and a receiver disposed thereon, wherein the first surface and the second surface are opposed surfaces of a deployable structure. The solar cells may be photovoltaic cells, thermophotovoltaic cells, or a combination thereof. The transmitter and/or the receiver may be three dimensional.

The solar power satellite sandwich module may include a docking interface configured for docking with at least one of: another satellite and a deployable scaffold. The solar power satellite sandwich module may include at least one deployable reflector for concentration and directing solar radiation and/or radiant heat onto the plurality of solar cells. The solar power satellite sandwich module may include a filter for regulating the amount of solar radiation and/or radiant heat directed to the plurality of solar cells.

The solar power satellite sandwich module may include a plurality of rectennas on a surface of the satellite for receiving electromagnetic radiation in one or more bands. The solar power satellite sandwich module may include a storage system for storing the energy generated by the plurality of solar cells and/or the plurality of rectennas.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIGS. 1A-1C are perspective views of a hybrid UAV in various configurations, according to an embodiment;

FIG. 2A are high altitude platform UAV relay stations, according to several embodiments;

FIGS. 2B-2C are side and top cross-sectional views of the fixed-wing UAV relay station in FIG. 2A;

FIG. 2D is a diagram of a high-altitude platform UAV relay system, according to an embodiment;

FIG. 3A is a modular deployable UAV, according to an embodiment;

FIG. 3B is a modular deployable UAV system for dynamic network management, according to an embodiment;

FIG. 3C is a magnetic tether and reel system, according to an embodiment;

FIG. 4A is a 3D phased array UAV, according to an embodiment;

FIG. 4B is a UAV configured for in-flight distributed field control, according to an embodiment;

FIGS. 5A-5D are diagrams of UAV deployment systems, according to several embodiments;

FIGS. 6A-6B are diagrams of a rapid deployment system, according to an embodiment;

FIG. 7 are diagrams of flight paths for a fleet of drones, according to several embodiments;

FIGS. 8A-8B, are top and bottom views, respectively, of a sandwich satellite module, according to an embodiment;

FIG. 8C is a diagram of an exemplary deployment of the sandwich satellite module shown in FIGS. 8A-8B.

FIGS. 8D-8F shows diagrams of exemplary applications for the sandwich satellite module shown in FIGS. 8A-8B;

FIG. 8G is a diagram of a space radar system using the sandwich satellite module network shown in FIG. 8F, according to an embodiment;

FIG. 9A is a diagram of operating environments for autonomous vehicle systems/networks, according to various embodiments;

FIG. 9B is an end-to-end solution implementing autonomous vehicle systems/networks, according to an embodiment;

FIG. 9C is a diagram of a search and rescue system using deployable, reusable autonomous vehicles, according to an embodiment;

FIG. 9D is a diagram of a communication and control system using deployable, reusable autonomous vehicles, according to an embodiment;

FIG. 9E is a diagram of a power transmission and communication system using deployable, reusable autonomous vehicles, according to an embodiment;

FIG. 9F-9G are a diagrams of a point-to-point payload transfer system using deployable, reusable autonomous vehicles, according to an embodiment;

FIG. 9H is a diagram of a point-to-point beam-riding system using deployable autonomous vehicles, according to an embodiment;

FIG. 9I is a diagram of a wildlife management system using deployable autonomous vehicles, according to an embodiment;

FIG. 9J is a diagram of a multi-direction beam-riding system using deployable autonomous vehicles, according to an embodiment;

FIG. 10A is a diagram of network topologies for wirelessly distributing power across a three-dimensional array of autonomous vehicles, according to several embodiments;

FIG. 10B is diagrams of system architectures for dynamic wireless power and data transmission, according to several embodiments;

FIG. 10C is a diagram of a local near-field wireless power transfer network, according to an embodiment;

FIG. 11A is a diagram of a traffic management transceiver structure 420, according to an embodiment;

FIG. 11B is a diagram of a deployable smart space system, according to an embodiment;

FIG. 12A is a diagram of a deployable data hub network for use in point-to-point data transmission, according to an embodiment;

FIG. 12B is a diagram of a rapidly deployable power hub system for point-to-point wireless power transmission, according to an embodiment;

FIG. 13A is a diagram of a deployment mesh system for a deploying wireless power and data distribution networks, according to an embodiment;

FIG. 13B are diagrams of deployment mesh systems, according to several embodiments;

FIG. 14 is a diagram of reusable autonomous vehicles networks deployed across multiple domains;

FIG. 15 is a diagram of an air-to-water system for wireless power transmission, according to an embodiment;

FIG. 16 is diagram of a space-to-earth wireless power and data transmission system, according to an embodiment;

FIG. 17 is a diagram of a space-to-air wireless power and data transmission system, according to an embodiment;

FIG. 18 is a diagram of in-space systems for wireless power and data transmission, according to several embodiments;

FIG. 19 is a diagram of command and control of autonomous vehicles, according to an embodiment;

FIGS. 20A-20C are diagrams of solar power satellite sandwich modules, according to several embodiments;

FIG. 21A, is a diagram of a top view of a sandwich SPS, according to an embodiment;

FIG. 21B is a diagram of a bottom side of the sandwich panel shown in FIG. 21A;

FIG. 21C is a diagram of a side view of the SPS sandwich module shown in FIG. 21A;

FIG. 21D is a diagram of a top view of a sandwich SPS, according to another embodiment; and

FIG. 21E is a diagram of a side view of the SPS sandwich module shown in FIG. 21D.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Herein, the use of “UAV” or “drone” means the same thing, namely, an unmanned aerial vehicle as part of an unmanned aircraft system and/or an unmanned network that is autonomous or remotely controlled by a pilot, unless otherwise stated.

### Mobile and Fixed Deployable and Reusable Nodes for Network Operations

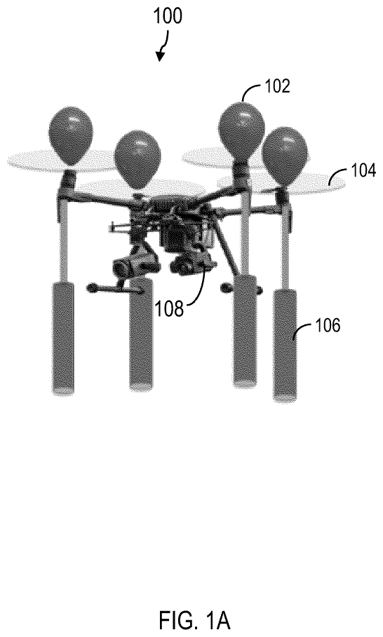

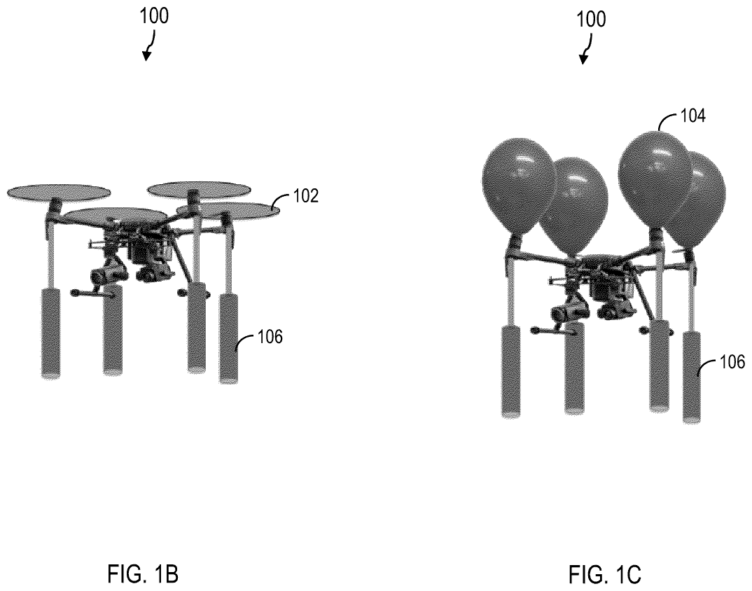

Referring to FIGS. 1A-1C, shown therein is a hybrid unmanned aerial vehicle (UAV) 100. The UAV 100 includes a hybrid propulsion system including at least one rotor/propeller 104 and at least one balloon 102. According to other embodiments, the UAV 100 may include a jet engine instead of rotors/propellers. Combined use of the propellers 104 and the balloons 102 may provide for slow, front, back and sideways movement as well as altitude adjustment. Generally, for fast movement and for take-off and landing, only the propellers 102 are used and the balloons 102 are fully deflated (FIG. 1B).

In a hovering configuration (FIG. 1C), the balloon 104 is fully inflated allowing the UAV 100 to levitate without use of the propellers 102. Beneficially, this saves electrical power that would otherwise be used to turn the propellers 102 to keep the UAV 100 hovering, and allows for the UAV 100 to remain airborne for longer durations.

The UAV 100 includes a volume control system for inflating and deflating the balloon 102. The volume control system utilizes a heating system similar to a hot air balloon, or pumps/compressors and gas cylinders, or both, to control inflating and deflating the balloon 102.

The UAV 100 includes one or more sensors/cameras/probes 108. The sensors 108 may be for navigation/control of the UAV 100 (e.g., cameras, radar, lidar sensors), or data collection in specific applications (e.g., gravimetric measurements, land surveying, wildlife, climate change, emergency response and other in-situ monitoring etc.). In other implementation, systems may be deploying giving the ability to rapidly restore communication infrastructure in areas of the country suffering from an unexpected major crisis that knocks out the communications infrastructure, such as natural disasters like ice storms and earthquakes or widespread fires. A plurality of unmanned aircraft systems can be networked to support continuous operations, that could almost instantaneously make entire markets 5G/6G ready, as well as supporting 2G, 3G, 4G, 5G and IoT backhaul and densification, enabling delivery of 4G/5G backhaul, enterprise wide area networks, residential broadband and sensor and IoT services. A plurality of unmanned aircraft systems coupled with machine learning and artificial intelligence, onboard processing can also provide first responders with critical real time information about how activities on the ground are unfolding to enable a rigorous and effective evidence-based decisions.

The UAV 100 includes one or more radio frequency (RF) antennas 106 (i.e., a transmitter, a receiver or a transceiver). In an application, the UAV 100 is moved into an aerial position and kept substantially stationary in the hovering configuration (FIG. 1C) for use as a RF relay station. The UAV 100 may be automated for remote operations wherein upon deployment the UAV 100 positions itself at a pre-determine aerial position to relay RF signals.

The UAV 100 includes a controller configured for executing a movement process and a communication process. The movement process includes deflating the balloon 104 and exerting propulsion and buoyancy through the propeller 102 and/or balloon 104 to position the drone. The communication process includes inflating the balloon 104, heating the fluid, reducing the power of the rotor and activating communications equipment e.g., the antenna 106.

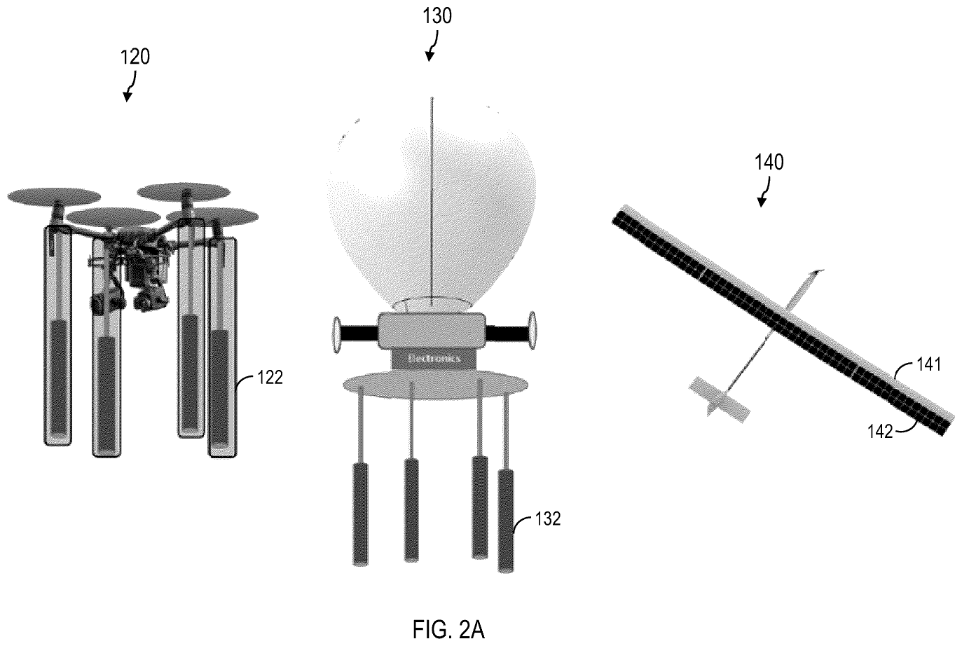

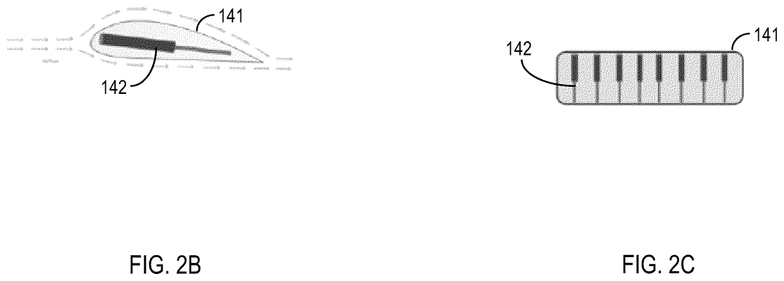

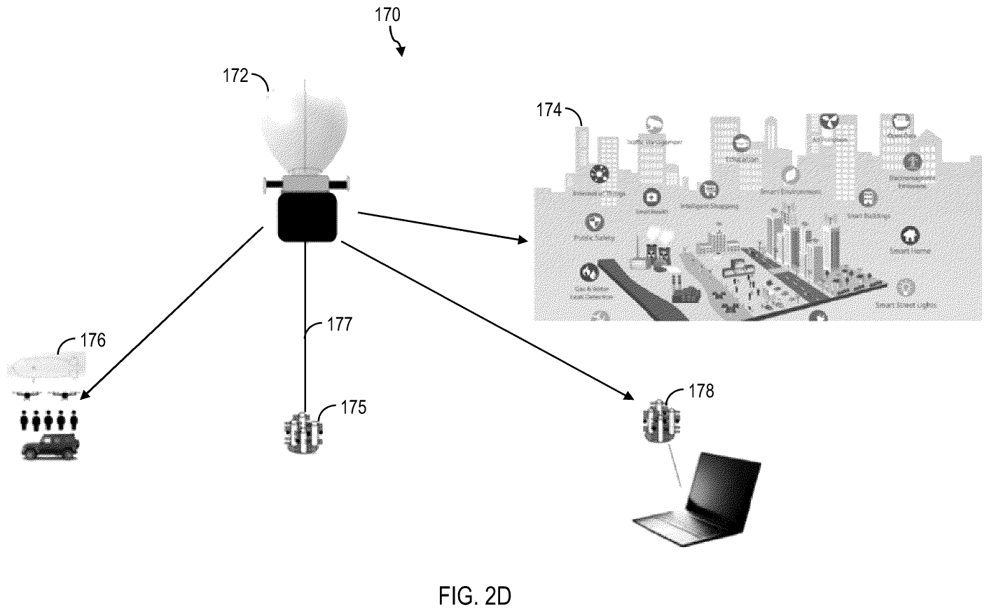

Referring to FIGS. 2A-2C, shown there are high altitude platform UAV relay stations 120, 130, 140, according to several embodiments. The UAV 120 is a multi-rotor system. The UAV 130 is an inflatable system (e.g., a balloon or airship). The UAV 140 is a fixed-wing system (e.g., a jet or propeller aircraft). Each high-altitude platform UAV relay station 120, 130, 140 includes a plurality of RF antennas 122, 132, 142 for relaying RF communications over a wide area. The UAV 130, being inflatable may be particularly well suited to high altitude operations, as it has no propellers which lose efficiency and may not be operable at high altitudes where air is thin. Referring to FIGS. 2B-2C, the wing 141 of the fixed wing UAV 140 includes antennas 142 within the wing 141 for reduced drag.

Referring to FIG. 2D, shown there is a diagram of a high-altitude platform UAV relay system 170, according to an embodiment. The UAV relay system 170 includes a high-altitude UAV relay station 172 having a plurality of antennas for relaying RF signals between smart city infrastructure 174, mobile devices 176 and ground stations 178. The high-altitude UAV relay station 172 is positioned at an altitude of 3 to 20 km above the ground, and can relay signals over a distance with a radius between 200 to 500 km.

The high-altitude UAV relay station 172 may be connected to a command and control station 175 on the ground. The UAV relay station 172 may be directly connected to the command and control station 175 by a tether 177 to supply the UAV relay station 172 with power and for control. In other implementations, the command and control station can be an extended reality platform (including mixed reality, virtual reality and/or augmented reality) for near-real time applications.

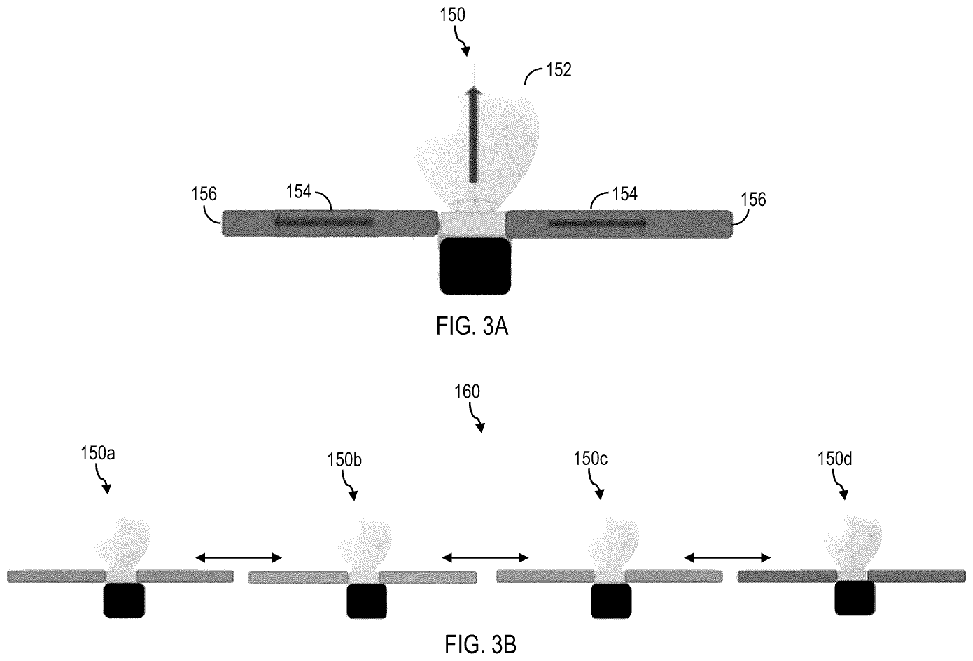

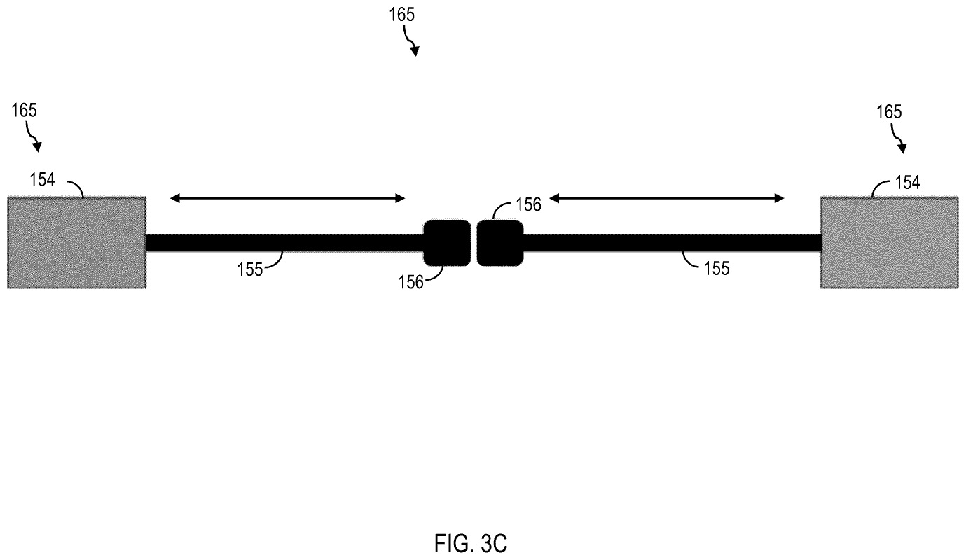

Referring to FIG. 3A, shown therein is a modular deployable UAV 150, according to an embodiment. The UAV 150 includes an inflatable balloon system 152 for propulsion. According to an embodiment, the inflatable balloon system 152 is an insulated balloon for reducing heat loss. The UAV 150 includes inflatable aerodynamic wings 154, that are inflatable and deployable in-flight. The wings 154 may be inflated and deployed using a liquid or gas or solid (gel) based system, or a combination thereof

The surfaces of the balloon 152 and wings 154 may be covered with solar panels, rectennas, and/or other power generation systems for powering the UAV 150. The ends of the wings 154 include docking interfaces 156 to attach to other UAVs to create a larger modular system/network (FIG. 3B). The docking interfaces 156 may use magnetic and/or electromagnetic coupling. In other implementations docking interfaces 156 may transmit and/or receive both power and or data. Furthermore, in other implementations, it may use a physical or mechanical connections for coupling and/or decoupling a plurality of robotic systems.

Referring to FIG. 3B, shown therein is a modular deployable UAV system 160 for dynamic network management, according to an embodiment. The system 160 includes a plurality of modular deployable UAVs 150a, 150b, 150c, 150d. The system 160 may be formed by individually raising and deploying each UAV 150a, 150b, 150c, 150d separately, and then connecting the UAVs by the docking interfaces in-flight.

The UAVs 150a, 150b, 150c, 150d may be autonomous and configured for autonomous deployment, synchronous operations with other UAVs, independent operations and mutual coupling to form the system 160. Each UAV 150a, 150b, 150c, 150d may be configured to perform a specific task/function in the system 160 when formed. The UAVs 150a, 150b, 150c, 150d also form a network for sharing data (including sensor data), power and propulsion for dynamic management of the system 160.

Referring to FIG. 3C, shown therein is a magnetic tether and reel system 165, according to an embodiment. The tether and reel system 165 may be used by the UAVs 150a, 150b to attached and form the modular deployable UAV system 160 shown in FIG. 3B. Each UAV 150a, 150b includes a deployable, extendable tether 155 on the wings 154. The ends of the tethers 155 include the magnetic docking interfaces 156. In other implementations an electromagnetic can be used to tether and reel a plurality of nodes.

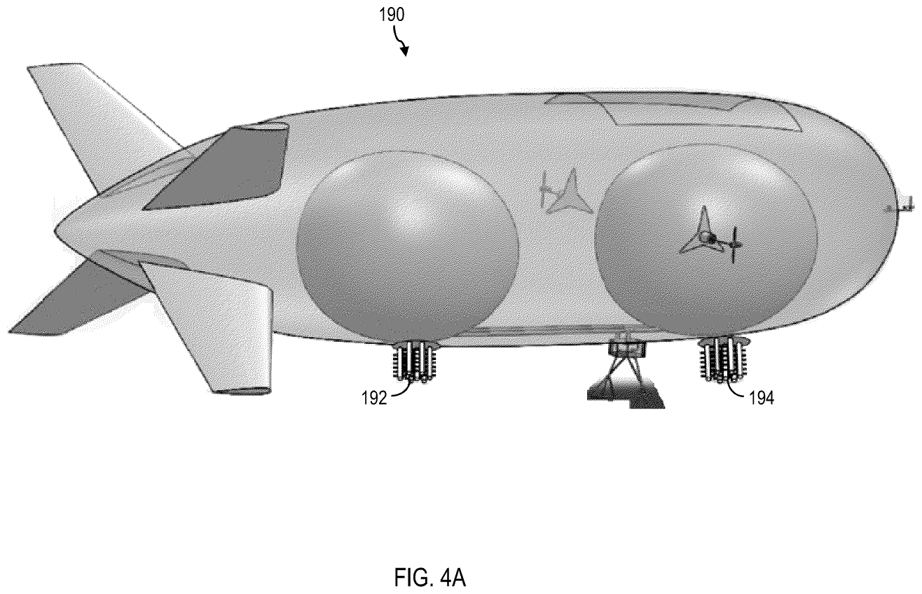

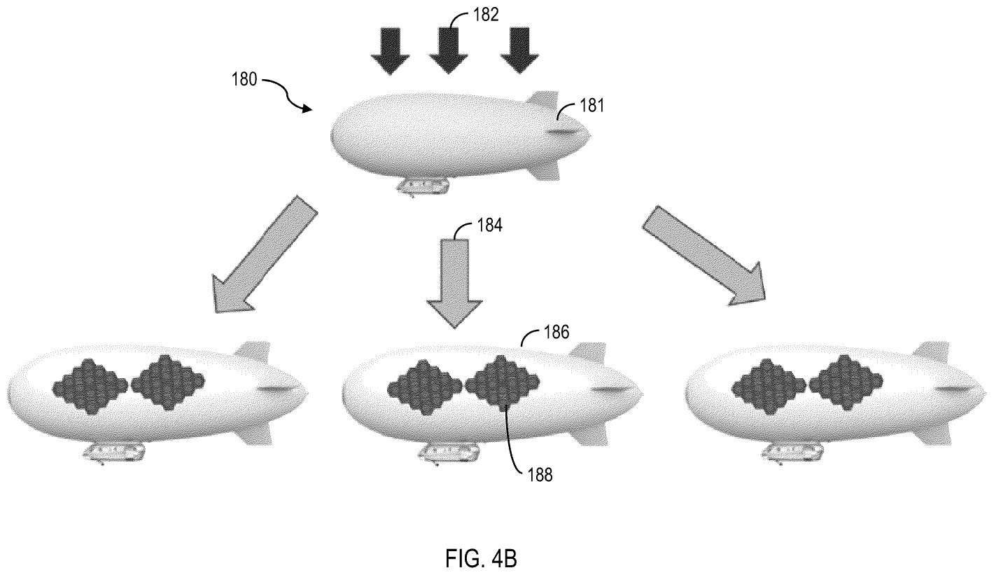

Referring to FIG. 4A, shown therein is a 3D phased array UAV 190, according to an embodiment. The 3D phased array UAV 190 incudes a transmitter antenna array 192 and a receiver antenna array 194. According to other embodiments, the antenna arrays 192, 194 may be disposed internal to the UAV 190 or may be deployable from the interior of the UAV 190.

Referring to FIG. 4B, shown therein is a deployable, reusable UAV, e.g., an airship 180 configured for in-flight distributed field control, according to an embodiment. The outer surface 181 of the airship 180 is constructed of metamaterials, or include meta-surfaces, to direct electromagnetic radiation 182 for adaptive field control for management of power and data networks.

The metamaterials or meta-surfaces on the outer surface 181 of the airship 180 may be arranged in a structure to be tunable to generate or receive a desired wavelength. For example, the outer surface 181 may include metamaterials that absorb a first wavelength of radiation 182 and generate a second wavelength of radiation 184. The generated radiation 184 may be directed to another airship 186 having rectenna arrays 188 for receiving the second wavelength of radiation 184.

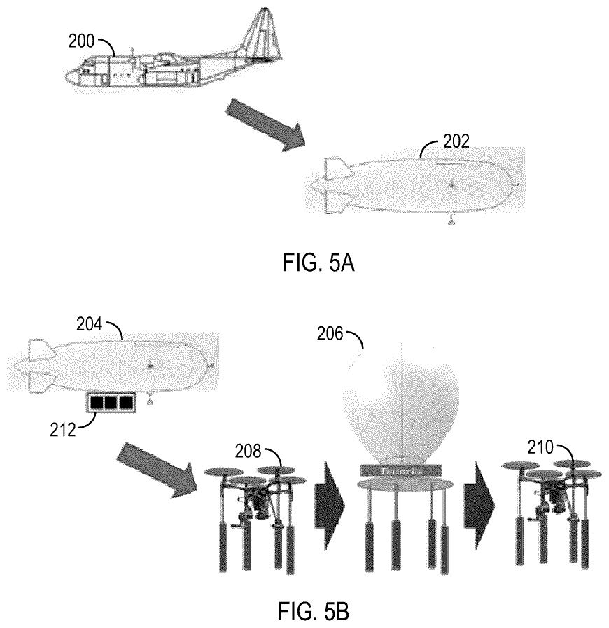

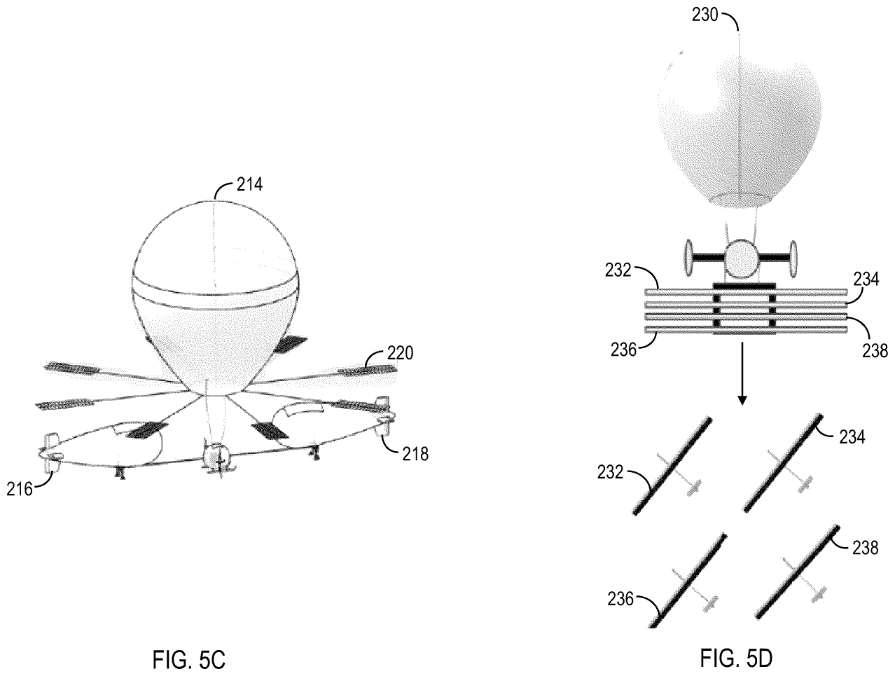

Referring to FIGS. 5A-5D shown therein are diagrams of UAV deployment systems, according to various embodiments. FIG. 5A shows an aircraft deployment system, wherein an aircraft 200 (e.g., a airplane, a jet, a helicopter) carries a UAV 202 from the ground and releases the UAV 202 in-flight. The UAV 202 may rendezvous with the aircraft 200 after completing its task. The aircraft 200 may recover the UAV 202 in-flight using a recovery system similar to the Fulton recovery system.

FIGS. 5B-5C show deployment systems for fleets of UAVs. FIG. 5B shows a UAV deployment system, wherein a UAV, e.g., an airship 204 is a mothership for a fleet of drones 206, 208, 210. The drones 206, 208, 210 are stored in a docking bay 212 of the airship 204 and are deployed therefrom in-flight. When in the docking bay 212, the drones 206, 208, 210 may be in a compact storage configuration and become inflated/expanded when deployed from the airship 204. The drones 206, 208, 210 may return to the docking bay 212 to recharge. In other implementations, the drones 206, 208, 210 may share energy between each other to optimize for flight and or other desired application via a physical connection and/or wireless power transmission.

FIG. 5C shows a UAV deployment system, wherein a UAV, e.g., a balloon 214 is a mothership for a fleet of drones 216, 218. The balloon 214 includes docking interfaces 220 for docking with the drones 216, 218. When docked, the drones 216, 218 can recharge. The balloon 214 may be tethered to a ground-based power source.

FIG. 5D shows a UAV deployment system, wherein a UAV, e.g., a balloon 230 is a mothership for a fleet of fixed-wing drones 232, 234, 236, 238. The balloon 230 carries the drones 232, 234, 236, 238 in a compact configuration. The balloon 230 deploys the drones 232, 234, 236, 238, by dropping them in free fall. While in free fall, the drone's wings are inflated/deployed to gain lift and flight.

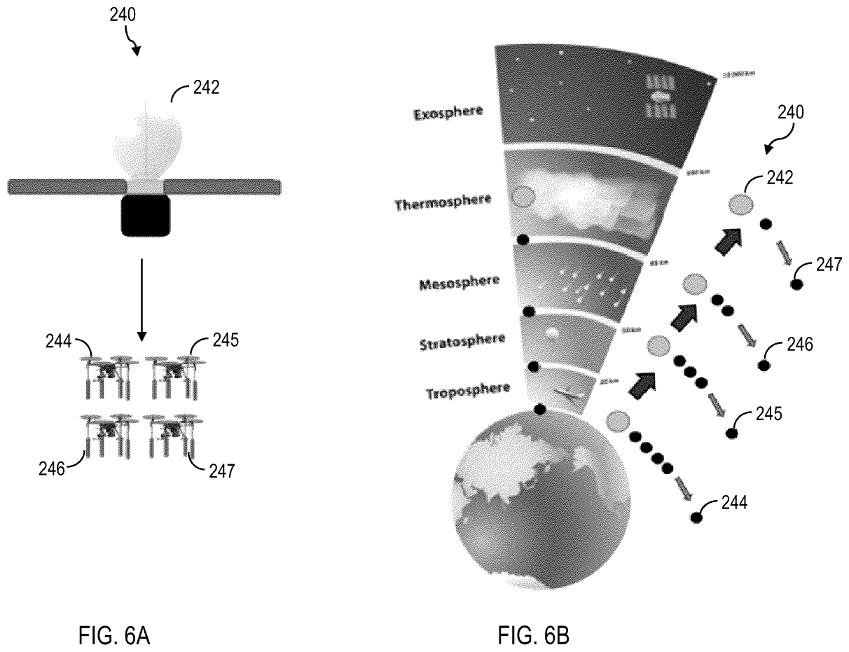

FIG. 6A is a diagram of a rapid deployment system 240, according to an embodiment. The rapid deployment system 240 includes a UAV, e.g., a balloon 242 for transporting a plurality of drones 244, 245, 246, 247. The drones 244, 245, 246, 247 may be carried by the balloon in a compact configuration and deployed in-flight.

Referring to FIG. 6B, shown therein is a diagram of an application for a rapid deployment system, according to an embodiment. The earth's atmosphere may be divided into spheres of operation corresponding to the various layers of the atmosphere (exosphere, thermosphere, stratosphere, etc.) As the balloon 242 rises to higher altitudes it deploys a drone 244 at each sphere of operation. The drones 244, 245, 246, 247, once deployed, may form a deployable network spanning various altitudes to provide service to systems below (e.g., relaying RF signals as shown in FIG. 2D) or above (i.e., satellites).

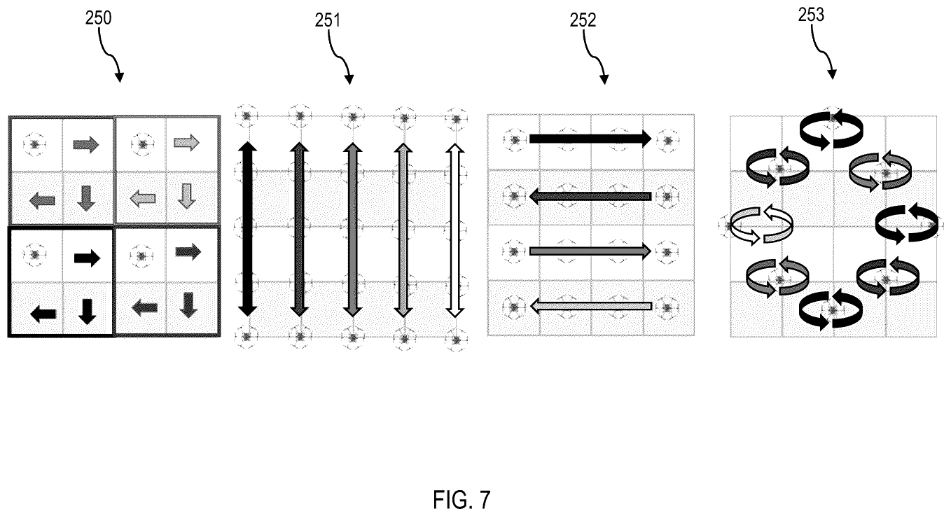

Referring to FIG. 7, shown therein is diagrams of flight paths 250, 251, 252, 253 for a fleet of drones, according to several embodiments. The fleet of drones may form a modular deployable network of drones. In FIG. 7, the differently shaded arrows indicate the lateral 2D flight paths of individual drones in the fleet. The drones may be configured to follow predetermined formation flight paths. The drones may be configured to adjust a predetermined flight path based on input received from RADAR, LIDAR, cameras and/or other drones in the network.

In the flight path 250, individual drones are assigned a quadrant of a larger area to patrol and proceed flying around the assigned quadrant in a predetermined path until their assigned quadrant is covered. In the flight paths 251, 252 each drone flies back and forth over the entire area and interchanges position with other drones. In the flight path 253, each drone flies in a circular or concentric path and maps the area below the path. A particular path 250, 251, 252, 253 may be used according to the specific application for the fleet of drones.

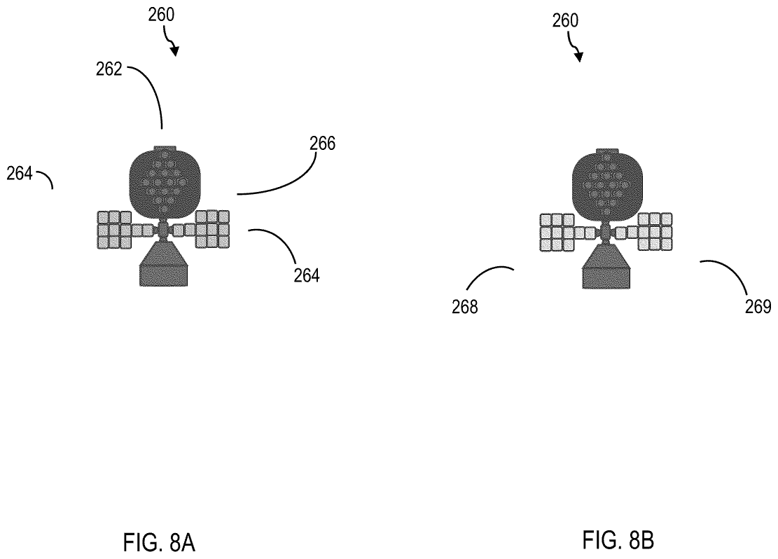

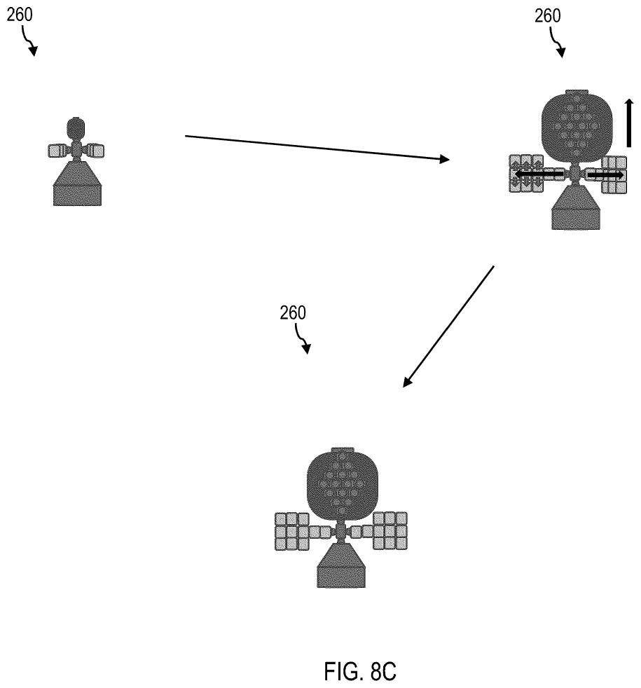

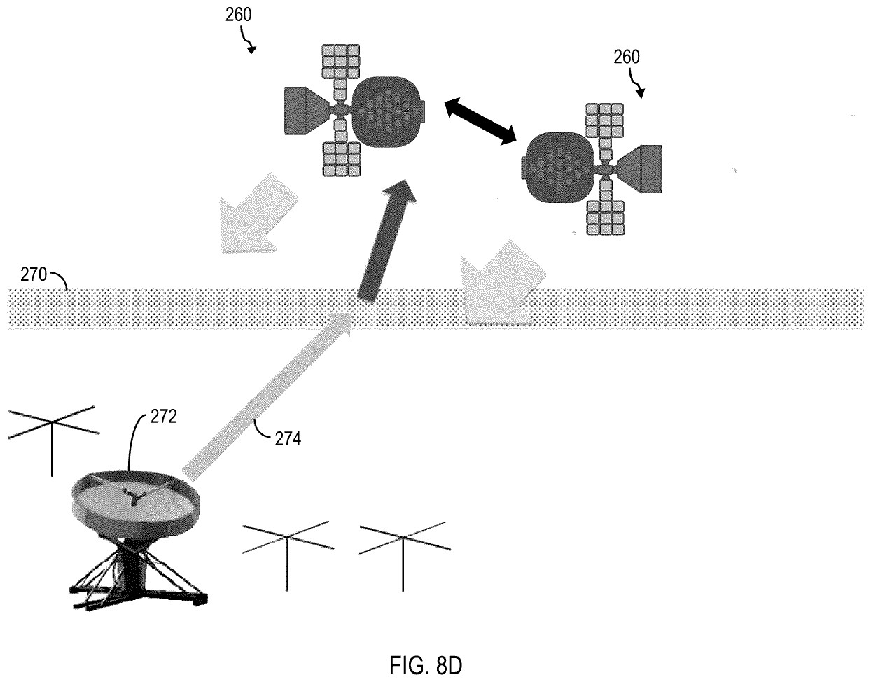

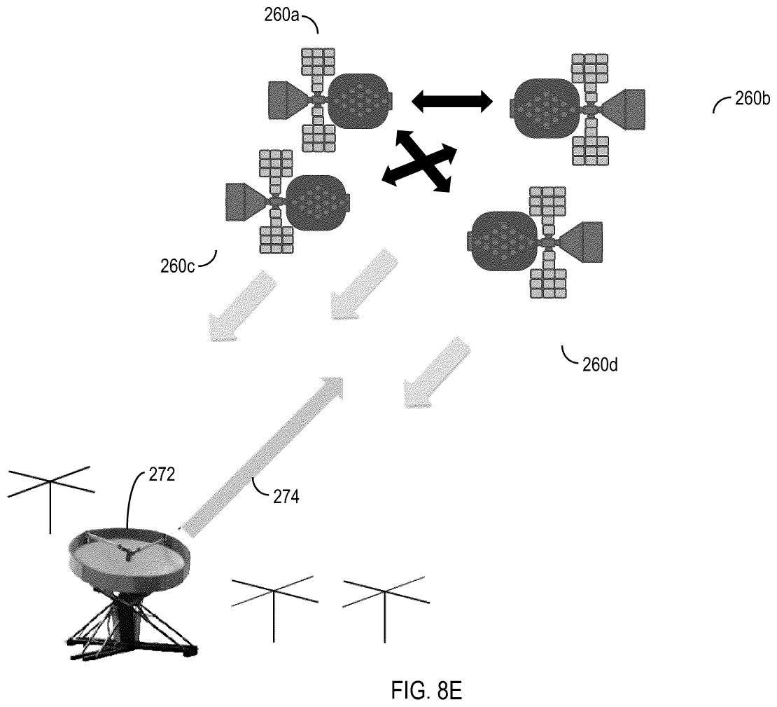

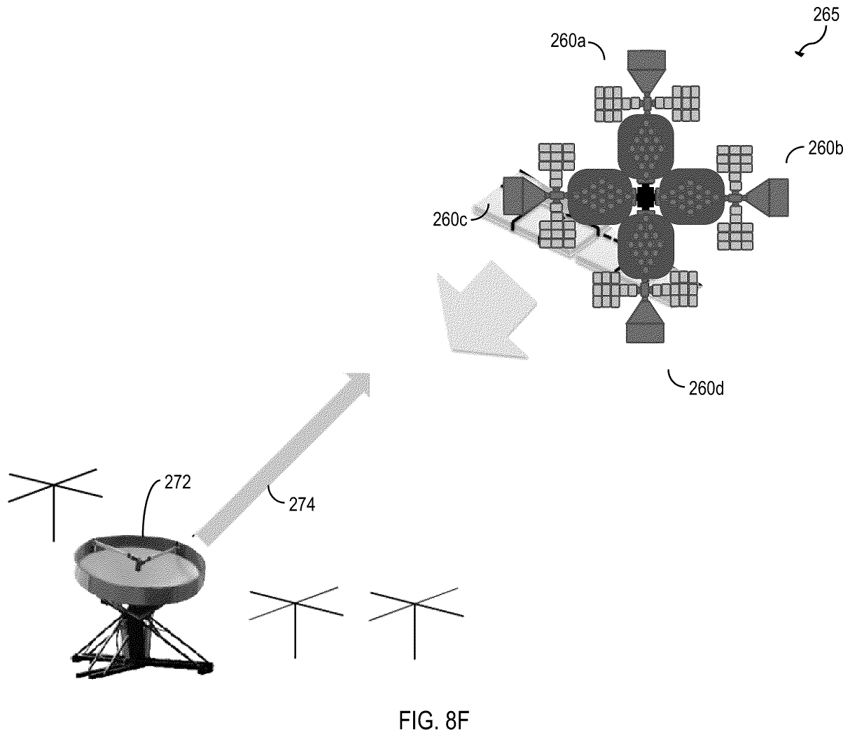

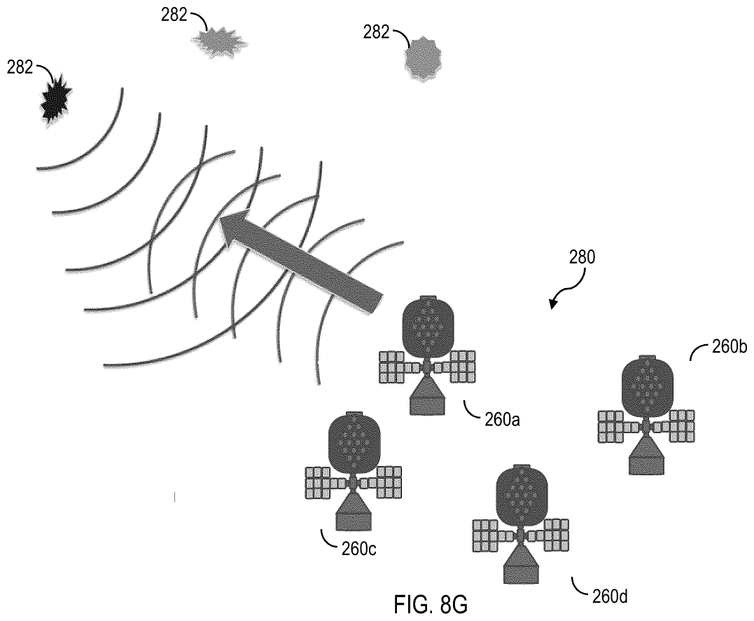

Referring to FIGS. 8A-8B, shown therein are top and bottom views, respectively, of a sandwich satellite module 260, according to an embodiment. The sandwich satellite module 260 includes a 3D phased array 262 and solar cells 264 on a top side (FIG. 8A). The sandwich satellite module includes electric circuits 266 for powering the phased array 262 using the solar cells 264. The sandwich satellite module 260 includes a microwave transmitter 268 and a pilot signal receiver 269 on a bottom side (FIG. 8B). When deployed, the sandwich satellite module 260 changes orientation, as required, to orient the solar cells 264 toward the sun and/or orient the transmitter 268 and receiver 269 toward the earth, another satellite, or planetary body to send/receive communication signals.

FIG. 8C shows an exemplary deployment of the sandwich satellite module 260 from a compact transport configuration to a deployed configuration.

FIGS. 8D-8F shows diagrams of exemplary applications for sandwich satellite modules, according to various embodiments. The sandwich satellite module 260 may receive a pilot signal 274 from a ground-based antenna 272. The pilot signal 274 may be a command or navigation signal to cause the sandwich satellite module 260 to, change orientation/position in orbit to interact with the ionosphere (FIG. 8D); fly in formation with other satellites for form a network for exchanging data or sharing power as needed (FIG. 8E); or dock with other satellites 260a, 260b, 260c, 260d to form a larger modular deployable system 265 to scale up power or data transmission as needed (FIG. 8F).

Referring to FIG. 8G, shown therein is a diagram of a space radar system 280 using a network of sandwich satellite modules 260a, 260b, 260c, 260d. The space radar system 280 includes an emitter satellite 260a which transmits radar waves and a plurality of receiver satellites 260b, 260c, 260d for detected reflected radar waves from objects 282 in space. The receiver satellites 260b, 260c, 260d may be positioned in orbit around the emitter satellite 260a. Using a plurality of receiver satellites 260b, 260c, 260d allows for triangulation of the received radar waves to accurately identify the position and distance of the detected object 282. The space radar system 280 may be particularly useful for detecting space debris 282.

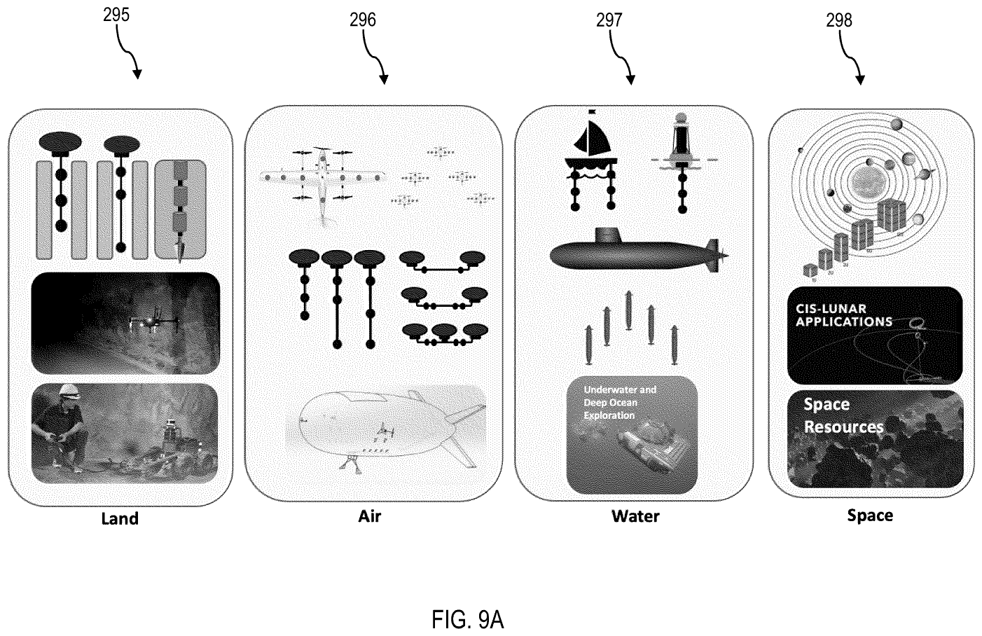

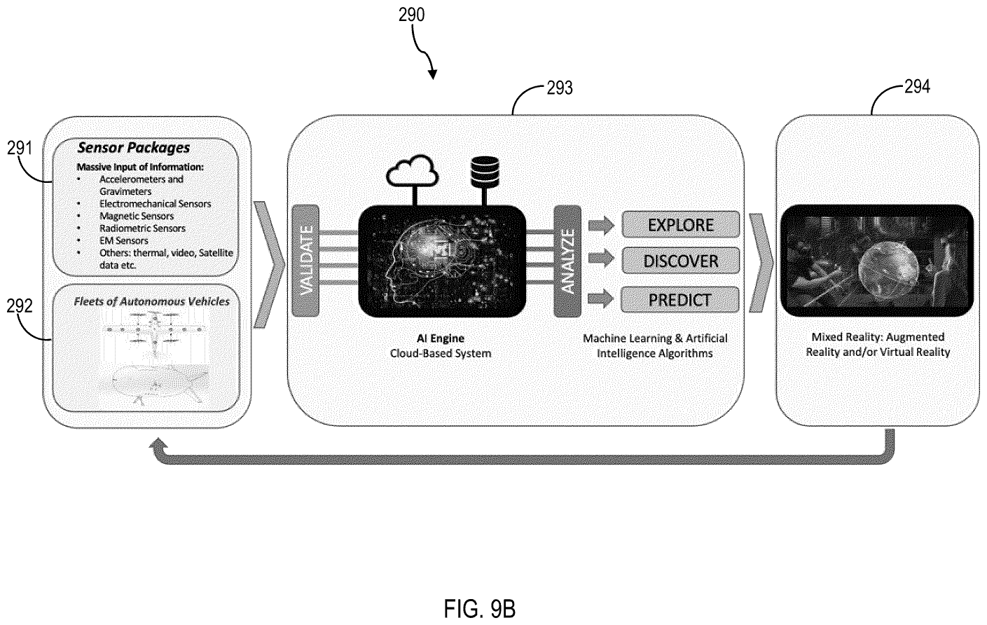

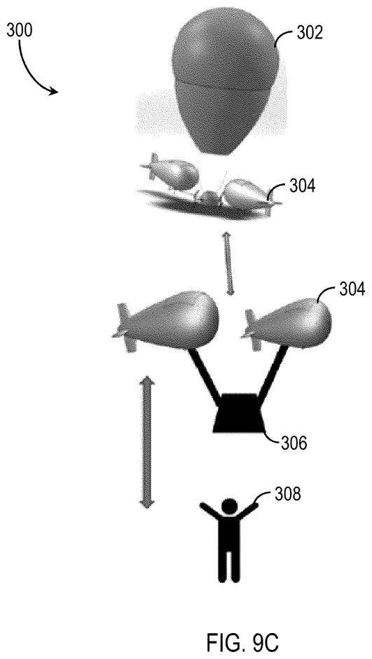

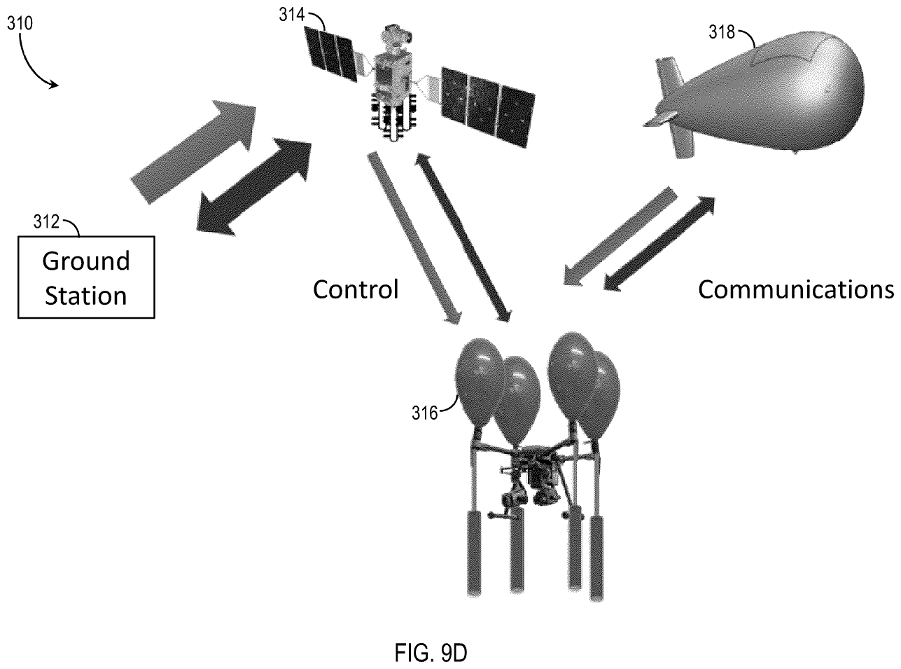

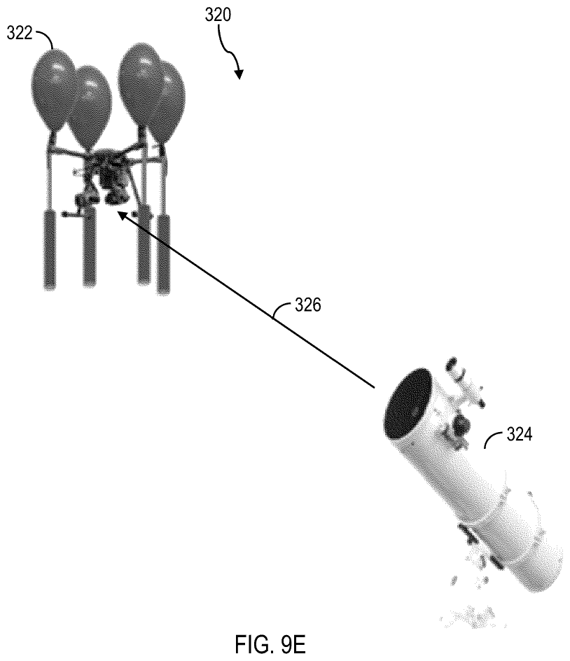

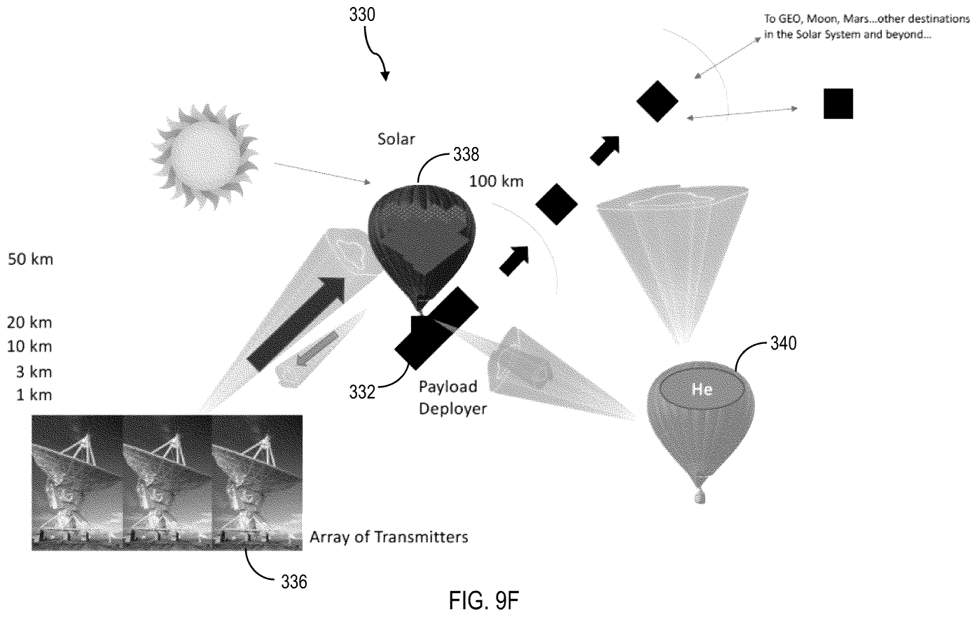

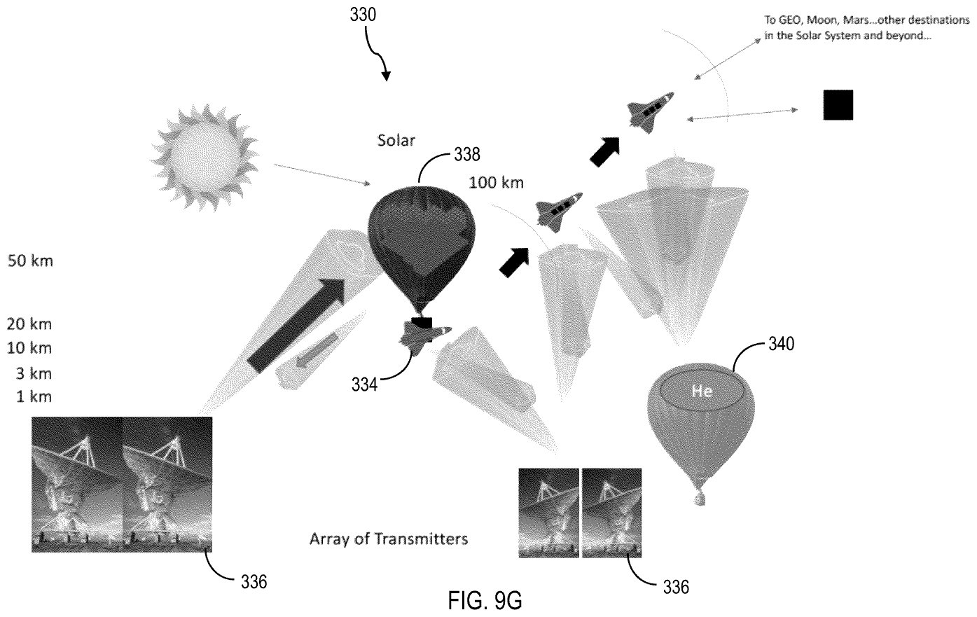

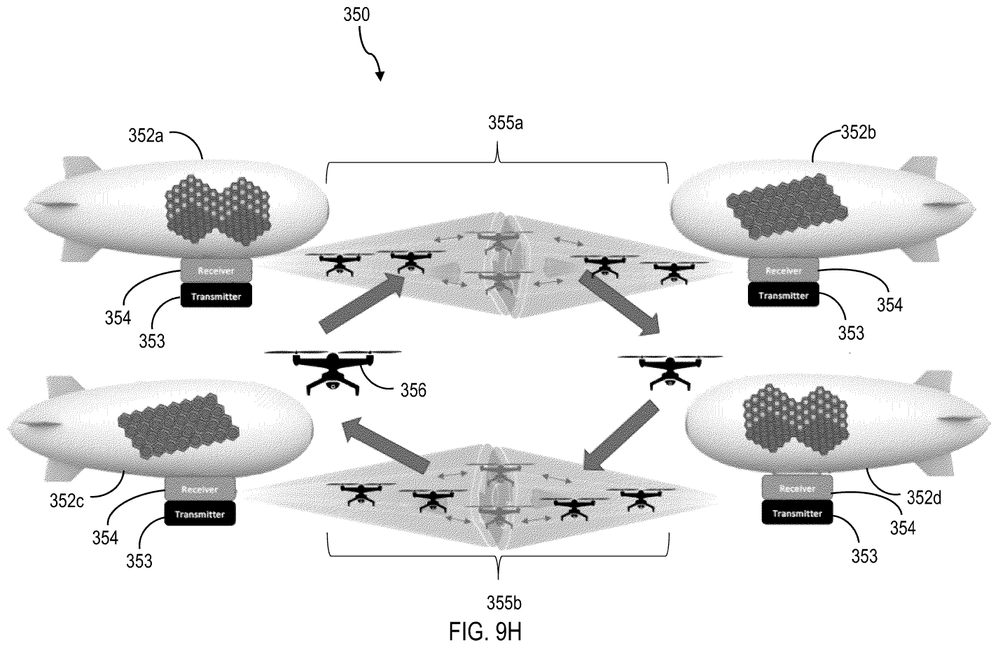

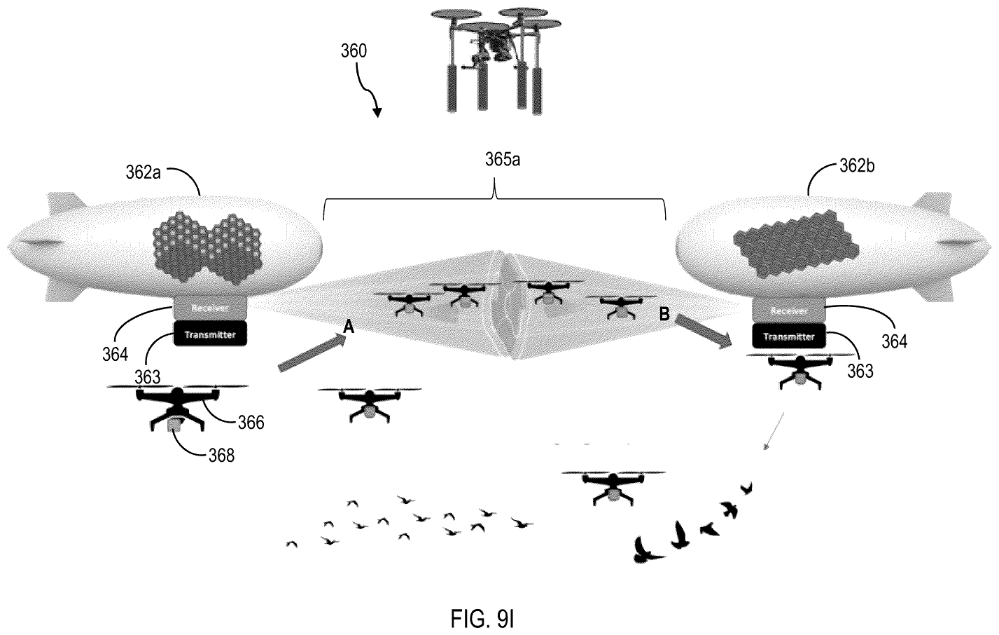

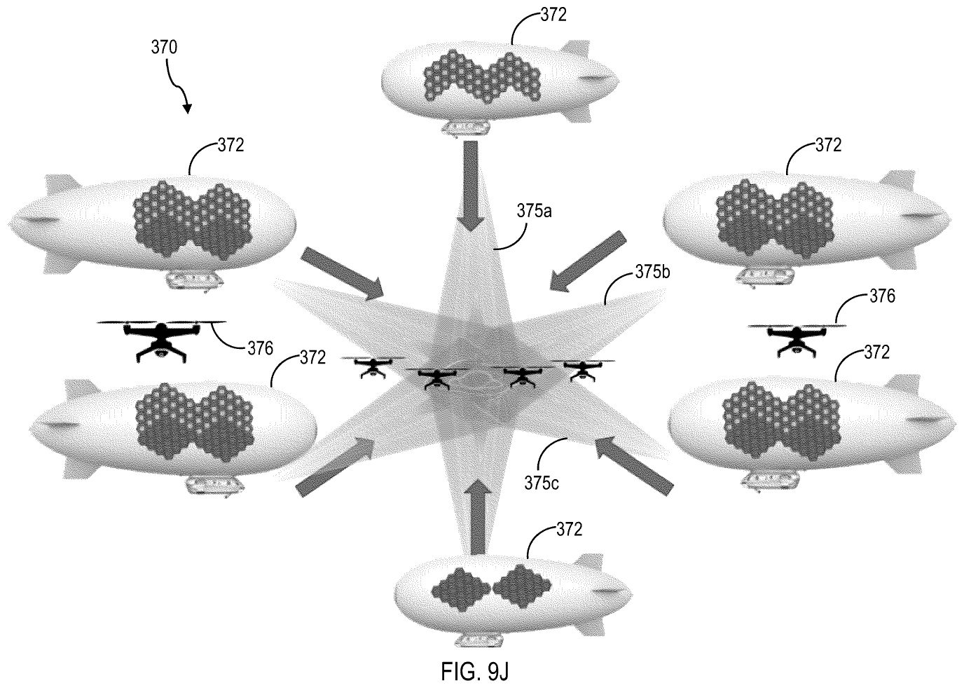

Referring to FIG. 9A, shown therein is a diagram of operating environments and applications for the autonomous vehicle systems/networks described herein. The scalable and modular nature of the autonomous vehicle systems described herein provide for operation in a variety of remote environments including a land/subterranean environment 295, an aerial/terrestrial environment 296, a water/underwater environment 297 and an outer space environment 298.

In a subterranean environment 295, autonomous vehicle systems may be deployed to augment underground operations (e.g., mining, resource extraction), to rapidly map, navigate, search, and exploit complex underground environments, including human-made tunnel systems, urban underground, and natural cave networks, or the like.

Aerial autonomous vehicle systems 296 may be deployed to map the subsurface geology by measuring density variations from a fleet of autonomous aerial systems equipped with customizable sensor packages, linked to a machine learning/artificial intelligence data processing pipeline, and visualized in a mixed reality environment.

Autonomous underwater vehicles can be used to map the underwater environments 297 on the ocean floor, deep ocean exploration, find resources, monitor climate change and study costal changes. For example, multi-beam echolocator data and gravity gradiometric data can be combined to map and monitor the seabed and investigate properties in a range of water depths.

In an outer space environment 298, autonomous spacecraft and satellites may be incorporated with a small satellite architecture, including cubesats or the like, to serve as a powerful cost-effective platform for space resources exploration, in orbit space services and space debris monitoring. For example, a generic satellite bus for asteroid rendezvous missions is currently under development to study asteroid size, shape, spin rate and direction, and tumbling rate. A constellation of cubesats with radar, gravity gradiometry and hyperspectral instruments are used for surveying and precise navigation to support asteroid mining (resource identification and utilization), cis-lunar missions, military application, intelligence gathering, security surveillance, and reconnaissance of space assets and monitoring of hostile actors.

Referring to FIG. 9B, shown therein is a diagram of an end-to-end solution 290 implementing autonomous vehicle systems/networks described herein, according to an embodiment. In the solution 290, one or more autonomous vehicle systems 292 are equipped with customizable sensors/sensor packages 291 to perform data collection/measurements. The sensors 291 may be configured for: resource identification, monitoring, and utilization (exploration, mining, extraction, processing, manufacturing, and stewardship of natural resources). The sensors 291 may further include RADAR, LIDAR and cameras and/or other navigation instruments for capturing a view of the environment to direct the path of the autonomous vehicles 292.

Flight operations of a fleet (or swarm) of autonomous vehicles 292 may be coordinated to maximize data collection. For example, the sensors 291 may be distributed across a population of autonomous vehicles 292 and predetermined flight paths are adapted to optimize for performance and for resource identification, tracking and in-situ monitoring, or the like. Different classes of autonomous vehicles 292 may be equipped with different sensor packages 291.

The autonomous vehicles 292 may be in constant motion and must be able to rapidly adapt to changing environmental conditions across one or more domains (i.e., on land, in the air or in space). Accordingly, artificial intelligence (AI)/machine learning (ML) engines and processes 293 may be employed for rapid, dynamic control and coordination of the autonomous vehicles 292. The AI/ML engines and processes 293 may transform the data/measurements from a plurality of sensors 191 for visualization in a extended reality environment (including mixed reality, virtual reality, and/or augmented reality) 294 by a human user to control operations of the autonomous vehicles 292.

Data and information collected by autonomous vehicle systems 292 may be processed onboard using the AI/ML engines and processes 293. According to other embodiments, the AI/ML engines and processes 293 may be cloud-based and connected to the autonomous vehicle systems 292 over a network via satellite uplink/downlink. The AI/ML engines and processes 293 may include: fleet management, autonomy and computer vision algorithms for directing the path of a single or a fleet of autonomous vehicles 292; algorithms for processing and visualizing the data from the sensors 291; and algorithms for generating results and insights for display using a user-interface on the web, mobile devices, and/or the extended reality environment 294, or the like. As more data is made available, processes may be improved and optimized in a feedback loop. For example, data acquisition may be optimized by adaptively varying the sampling frequency based on high noise in past measurements. In other implementations, data acquisition could be continuous but actual processed data points may be acquired at a desired point in space to perform semi-static point measurements to systematically improve the resolution and reduce noise.

The AI/ML engines and processes 293 will ingest and analyze the data from the sensors 192 and develop/refine machine learning and statistical models for classification and/or regression type analysis in real-time. A combination of four commonly known machine learning (ML) models may be implemented, namely: supervised learning, unsupervised learning, semi-supervised learning and reinforcement learning. Depending on the type of data that is input to the data system 106, these algorithms will be used for the purpose of classification, regression, clustering and dimensionality reduction. In other implementations, the AI/ML engines and processes 293 may employ deep learning and or neural networks or the like.

Using the above machine learning models that will iteratively examine the data and learn patterns, trends, rules and relationships from it, and over time, continue to improve and grow these models as and when more data becomes available. By aggregating data from multiple feeds/sensors (e.g., hyperspectral, lidar, gravity, seismic data, etc.) and continually analyzing all sources of information simultaneously, the maximum mutual information on desired space domain aware criteria can be obtained and enable going from data to discovery of resources, mapping of environment, etc.

Data and information output from the AI/ML engines and processes 293 can be displayed using a user-interface on the web, mobile devices, and/or the mixed reality environment 294. Extended Reality (XR) (including Mixed Reality (MR), Augmented Reality (AR) and Virtual Reality (VR)) tools provide an immersive and interactive way of displaying complex information to analyze the data and gain insights. AR technologies deliver information in a 3D space, where real-time processing areas of interest can be quickly identified to establish data-driven processes for evidence-based decision making. VR technologies can enable operators' new perspectives and visualizations to identify patterns and anomalies in the data. Symbology and data for specific applications will be developed with customer feedback, and new features and capabilities may be developed and deployed. Haptic feedback can also be integrated to recreating the feeling of vibrations, touch, and pressure to send subtle signals to users using XR.

The deployable and reusable autonomous vehicle systems/networks described herein may be used in a variety of applications, not limited to: a deployable back-up emergency network for supporting existing wired or wireless networks; search and rescue applications; disaster management; mobile backhaul services; fire prevention and management; wildlife protection and management; in-situ monitoring and data collection from IoT sensors; deployable smart cities, shared services between first responders (including law enforcement, paramedics, emergency medical technicians and firefighters), shared private and public networks, power and data application for the sharing economy, asset tracking and transportation services such as ride-sharing, taxis using electric vehicles (airships, aircraft, drones, cars, boats, trains, planes electric motorcycles, bikes and scooters or the like) tracking and monitoring of rockets and hypersonic and/or supersonic vehicles; deployable radar; air and space traffic management, validation and verification services; supporting aircraft services for tracking and managing mobile systems; surveying; land and resource utilization; and climate change and environmental assessment. Several applications are described in detail below.

Referring to FIG. 9C, shown therein is a diagram of a search and rescue system 300 using deployable, reusable autonomous vehicles, according to an embodiment. The search and rescue system 300 includes a UAV, e.g., an airship 302, that is stationed at a position in-air. The airship 302 may be stationed over an area where emergency services are limited or distant. The airship 302 is a mothership for a deployable rescue drone 304. The drone 304 includes a harness 306, or the like, for attaching to a human 308 and raising the human 308 up from the ground, similar to the Fulton surface-to-air recovery system. The drone 304 and/or airship 302 may be configured to employ a pre-programmed emergency rescue protocol to pick up the human 308 in response to receiving a signal, e.g., an SOS in morse code, or the like. The drone 304 and/or airship 302 may be signalled to rescue the human 308 by a gesture or voice command from the human 308. In other implementation, deployable, reusable autonomous vehicles may be integrated with local emergency, distress, search and rescue and other emergency channels for rapid response.

Referring to FIG. 9D, shown therein is a diagram of a communication and control system 310 using deployable, reusable autonomous vehicles, according to an embodiment. The communication and control system 310 includes a ground control station 312. The ground control station 312 sends command and control signals to a plurality of satellites 314 and drones 316, 318. The satellite 314 and drones 316, 318 may be positioned at variable altitudes to enable relaying of command and control signals beyond line of sight. The communication and control system 310 relays the signals from the ground station 312 through the satellite 314 to the drones 316, 318. Communications from the drones 316, 316 are relayed to the ground station 312 through the satellite 314. According to other embodiments, the signals from the ground station 312 are relayed to the satellite 314 through the drones 316, 318.

Referring to FIG. 9E, shown therein is a diagram of a power transmission and communication system 320 using deployable, reusable autonomous vehicles, according to an embodiment. The power transmission system 320 includes a UAV, e.g., a multi-copter 322 and a transmitter 324 for beaming electromagnetic radiation 326 up to the multi-copter 322.

The multi-copter 322 includes rectennas for receiving the electromagnetic radiation 326 and converting it to electrical current to power the multi-copter 322 systems. The multi-copter 322 and the transmitter 324 must be positioned and oriented appropriately for the radiation 326 to be received by the multi-copter 322. The radiation 326 may be microwaves, or laser radiation. Depending on the distance between the multi-copter 322 and the transmitter 324, a suitable band/wavelength of electromagnetic 326 radiation may be used.

Referring to FIGS. 9F-9G, shown therein are diagrams of a point-to-point payload transfer system 330 using deployable, reusable autonomous vehicles, according to an embodiment. The system 330 may be used to transport a payload 332 from the ground to orbit (FIG. 9F) or launch a spacecraft 334 into orbit (FIG. 9G).

The system 330 includes an array of ground transmitters 336 for beaming up electromagnetic radiation (wireless power). The system 330 includes a launch balloon 338 for carrying the payload 332 or the spacecraft 334. The launch balloon 338 is covered in rectennas to receive the radiation beamed up from the ground transmitters 336 and/or solar radiation to provide the launch balloon 338 with energy for propulsion and lift to carry the payload 332/spacecraft 334. The launch balloon 338 may transport the payload 332/spacecraft 334 up to an altitude of approximately 50 km above the earth. Beneficially this may save fuel and reduce the overall use of the payload since conventional (solid, liquid) fuel does not need to be carried.

The system 330 includes a secondary airship 340. The secondary airship 340 may track flight path of the launch balloon 338, deployment of payloads 332, 334 and/or interface with satellites in orbit. Tracking may be particularly useful when the payload is an autonomous weapons system e.g., hypersonic/ballistic missiles. Referring to FIG. 9G, the spacecraft 334 may include a heat exchanger (i.e., thermal rectennas) that can use directed power/radiation, from, for example, the secondary airship 340, for power and propulsion once separated from the launch balloon 338. In other implementations, supersonic, hypersonic, spacecraft and/or rocket bodies (including single stage to orbit and or multi-stage to orbit systems) may be wirelessly powered on entry or re-entry from one domain to another. In other implementations, where the mobile vehicles may transfer command and control to the network for controlled and or autonomous re-entry and/or landing.

FIG. 9H is a diagram a point-to-point (P2P) beam-riding system using deployable autonomous vehicles, according to an embodiment. The P2P beam riding system 350 includes at least a pair of craft 352a, 352b (a second pair of craft 352c, 352d is also shown). The craft 352a, 352b, 352c, 352d may be autonomous or semi-autonomous airships (as shown), balloons or drones (i.e., unmanned aerial vehicles, UAVs). Each craft 352a, 352b, 352c, 352d includes at least one transmitter 353 and at least one receiver 354 for transmitting and receiving, respectively, EM radiation, for example, microwave radiation. The craft 352a, 352b, 352c, 352d are positioned (in the air) in pairs such that the EM radiation transmitted by a first craft 352a, 352c is received by a second craft 352b, 352d.

The radiation transmitted and received between the craft produces a beam riding “highway” (shaded regions indicated by reference numbers 355a, 355b), or a microwave tunnel in the case of microwave radiation, in a volume of air between the craft. The beam riding highway 355a, 355b may be utilized for wireless power transfer (WPT), wireless data transfer between the craft 352a, 352b as well as providing over-the-air charging, command and control functions, for beam riding aerial craft (e.g., drone 356) that can be powered and/or recharged by microwave radiation.

Each beam riding highway 355a, 355b is directional, that is the direction of radiation transmitted between the craft 352a, 352b is in one direction. The direction of radiation transmission between the craft 352a, 352b may be reversed. Consequently, the drone 356, may only “ride” the beam riding highway 355a, 355b in the direction of radiation transmission. A shown, the direction of radiation transmission in the first beam riding highway 355a, and the direction of travel for the drone 356 within the first beam highway 355a is generally in the direction from craft 352a to craft 352b. The direction of radiation transmission in the second beam riding highway 355b, and the direction of travel for the drone 356 within the second beam highway 355b is generally in the direction from craft 352c to 352d. For example, the drone 356 may enter the first beam riding highway 355a in the vicinity of the craft 352a and ride the first beam riding highway 355a between the craft 352a, 352b, then exit the first beam riding highway 355a in the vicinity of craft 352b.

FIG. 9I is a wildlife management system 360 using deployable autonomous vehicles, according to an embodiment. The system 360 is substantially similar to the system 350 in FIG. 9H, and includes a pair of aerial craft 362a, 362b that produce a microwave beam riding highway 365a between them. The drone 366 includes a rectenna rechargeable power source 368. The power source 368 may be recharged by the drone 366 entering the beam riding highway 365a so that the rectenna receives microwave radiation and converts it to electricity that is stored in the power source 368.

The drone 366 is used for wildlife management applications in the vicinity of an area of interest, such as an airport to keep birds away from aircraft flight paths. When the drone 366 is low on power, it may fly into the beam riding highway 365a, for example, at point A to recharge the power source 368. As the drone 366 travels between the aerial craft 362a, 362b along the beam riding highway 365a, the power source 368 is recharged. When the power source 368 is sufficiently charged, the drone 366 exits the beam riding highway 365a, for example, at point B and may then return to its operational mode of keeping birds away.

As noted above, the travel of the drone 366 along the beam riding highway is in one direction only (the same direction of microwave radiation transmission between the aerial craft 362a, 362b) to allow the drone 366 maximum exposure to microwave radiation in order to charge the power source to sufficient levels required for operation. The drone 366 may travel a further distance along the beam riding highway 365a to recharge the power source 368 more.

FIG. 9J is a diagram of a multi-direction beam-riding system 370 using deployable autonomous vehicles, according to an embodiment. One or more beam riding highways 375a, 375b, 375c may be implemented within the point-to-point beam rising system 370 to allow for bidirectional or multi-directional travel of a beam riding drone 376. Accordingly, the drone 376 may ride one beam riding highway 375a to travel in one direction and ride another beam riding highway 375b to travel in another direction. Generally, a beam riding highway 375 may be implemented to travel in any direction between appropriately positioned aerial craft 372. The direction of travel of the drone 376 along the beam riding highways 375a, 375b, 375c may result in a change altitude, a change in position at the same altitude or a change in altitude and position of the drone 376.

### Power Distribution in Adaptive and Dynamic Autonomous Vehicle Nodal Networks

The autonomous vehicle systems/networks described herein can be configured to operate as a network of autonomous vehicle nodes that adapt to dynamic changes in the environment. Data is transferred between the nodes such that where one node receives data about the environment, the entire network can adapt to that environmental data. Power can also be shared and distributed across notes. Described below are several network topologies and architectures suitable for implementing a distributed wireless transfer nodal network of deployable, reusable autonomous vehicles.

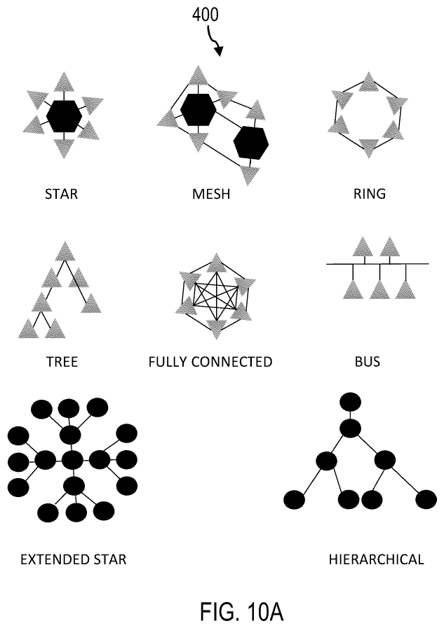

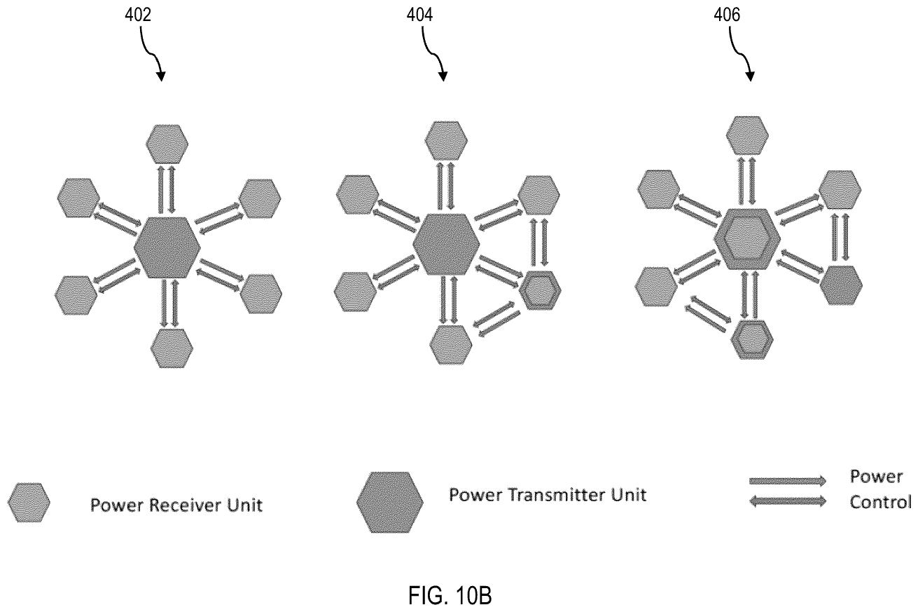

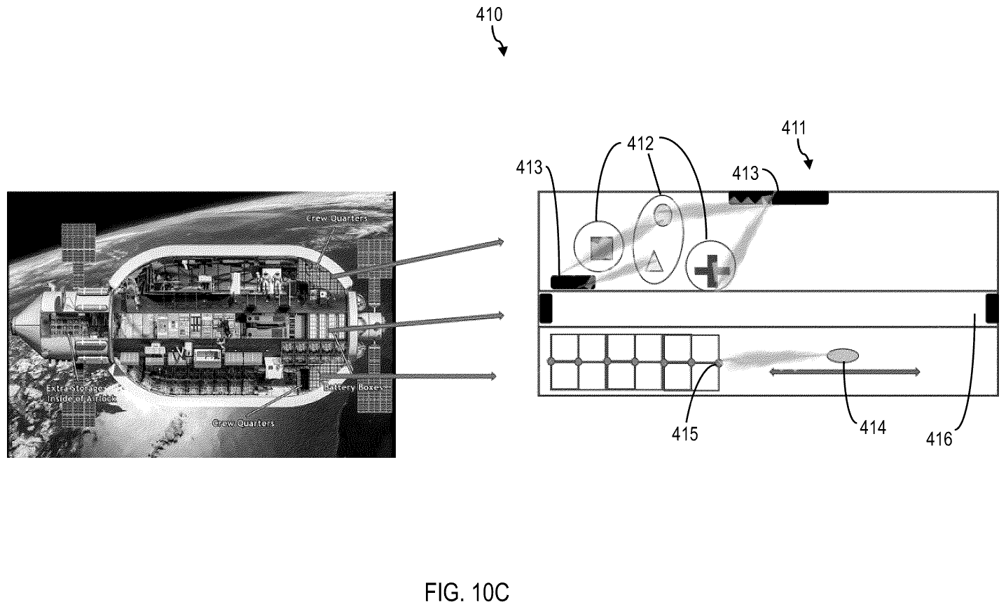

Referring to FIG. 10A shown therein is a diagram of power and data network topologies 400 for wirelessly distributing power across a three-dimensional array of autonomous vehicles, according to several embodiments. The three-dimensional array of autonomous vehicles could be continuous like a crystalline structure, or random like a flock of birds. The autonomous vehicles may be drones, or other aerial craft, satellites, or spacecraft, collectively referred to as nodes. The nodes may be fixed, mobile or hybrid systems including tethered systems having tethered components on the ground and in the air; or having tethered components in the air and in space. The nodes may transmit and receive power wirelessly and store the power. Charging a distributed array of nodes may be done using one or more of the network topologies 400 shown. Sharing power may occur by transferring power from a power source to a node; then node to node (i.e., a power relay system) to dynamically manage power systems to optimize stored energy amongst nodes.

Referring to FIG. 10B, shown therein are diagrams of system architectures 402, 404, 406 for dynamic wireless power and data transmission, according to several embodiments. Each of the power receiver and power transmitter units depicted in the architectures 402, 404, 406 may be located on an aerial craft that is part of a larger fleet or swarm of aerial craft.

A central system architecture 402 includes a central transmitter unit surrounded by receiver units. Power is wirelessly transmitted one-way from the central transmitter unit to each of the receiver units. Control (data) signals may be wirelessly transmitted two-way between the central unit and any of the receiver units.

A distributed system architecture 404 includes a central power transmitter unit, a power transmitter/receiver unit and several receiver units surrounding the central transmitter unit. The central transmitter unit transmits power to each of the surround receiver units including the transmitter/receiver unit. The transmitter/receiver unit may also transmit power to adjacent receiver units. Control (data) signals may be wirelessly transmitted two-way between the central transmitter unit and any of the receiver units as well as between the transmitter/receiver unit and adjacent receiver units.

A hybrid system architecture 406 includes a central power transmitter/receiver unit surrounded by several receiver units, a power transmitter unit and a second power transmitter/receiver unit. The central transmitter/receiver unit may transmit power to any of the surrounding receiving units. The power transmitter unit may transfer power only to the adjacent receiving unit and central transmitter/receiver unit. Similarly, the second power transmitter/receiver unit may only transmit power to the adjacent receiving unit and the central transmitter/receiver unit. Control signals may be wirelessly transmitted two-way between the central transmitter/receiver unit and any of the surrounding receiver units, the power transmitter unit and the second transmitter/receiver unit, as well as between the transmitter/receiver unit and adjacent receiver units.

Distributed, deployable networks using the autonomous vehicles described herein as power and/or data nodes, may be employed for point-to-point wireless data and power transmission, including near-field (up to several meters) and far-field (longer distances) transmission. Such networks may be deployed as micro- or macro-mobile smart grids, when/where they are needed, to support local activities. Extra/surplus power that is generated or received by nodes in the network can be shared between nodes or transmitted to other devices.

Near-field distributed wireless transfer networks may include inductively-coupled systems or magnetically coupled systems having a plurality of resonance coils for wireless energy transfer such as those disclosed in International Patent Application No. PCT/CA2021/050985, to the same applicant, which is wholly incorporated by reference herein. Local near-field wireless power transfer networks can be deployed to power robotic, biomechatronic, bionics, biorobotics or android applications wherein robotic systems are used as human augmentation technologies. In an example, a near-field micro grid may be used to power robots in a warehouse-during the day a relatively low amount of EM radiation may be beamed to the robots from a transmitter in the ceiling to avoid adverse effects of radiation on humans; at night, the transmitter can transmit at a higher intensity when humans are not present.

Referring to FIG. 10C, shown therein is a diagram of a local near-field wireless power transfer network 410, according to an embodiment. The local near-field power transfer network 410 is in a spacecraft or space station crew quarters 411. The power transfer network 410 includes a plurality of fixed transmitters 413 and mobile transmitters 414 (e.g., on UAVs) for beaming electromagnetic radiation for wireless power transfer. The network 410 includes devices 412, 415 having receivers for receiving the electromagnetic radiation beamed by the transmitters 413, 414 for recharging the devices 412, 415 by wireless power transfer.

The power transfer network 410 can operate constantly to recharge the devices 412, 415. However, high amounts of electromagnetic radiation exposure can be harmful to humans. Accordingly, the power transfer network 410 may be configured to operate when the crew quarters 411 are unoccupied. Alternatively, or in addition, a shielded corridor 416 may provide for small amounts of electromagnetic radiation to pass through to recharge wearable and embedded systems on astronaut spacesuits within the confines of a corridor 416.

Far-field distributed wireless transfer networks can be used to transmit data and/or power across large distances and across multiple domains (i.e., land-to-air-to-space). Such systems may be employed for distributed computing across domains, as well as distributing energy across domains. For example, using deployable airships, power can be transmitted to receiving stations on the ground to power devices on the ground.

Hybrid wireless transfer networks may include both near-field and far-field transmission. Such a system can alternatively use near-field or far-field transmission to avoid interference in urban areas where there are numerous wireless devices. As an example, a hybrid system may be employed in a rural area to use near-field energy transfer to supply power to devices during the day, and use far-field energy transfer (higher-intensity energy) at night when is it safer to do so.

Distributed, deployable wireless transfer networks must be configured to avoid interference between the various bands of electromagnetic radiation that are used to wirelessly transfer power and/or data. Several transceiver arrangements for wireless transfer networks are described below.

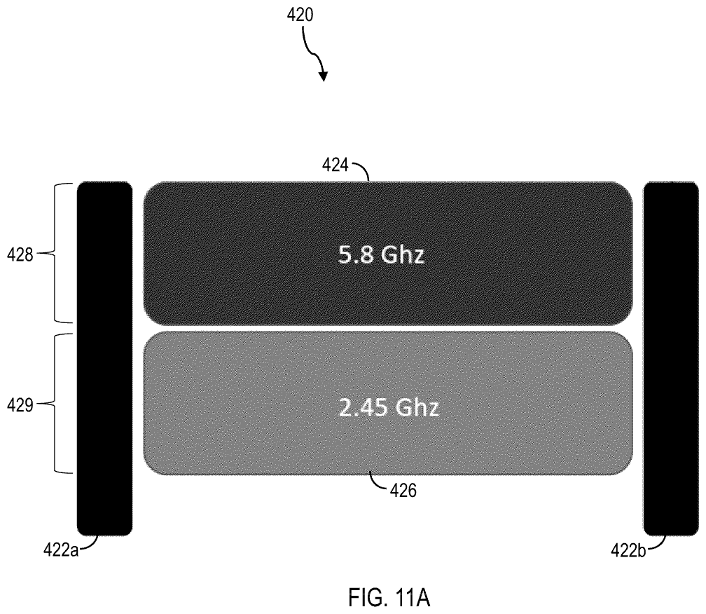

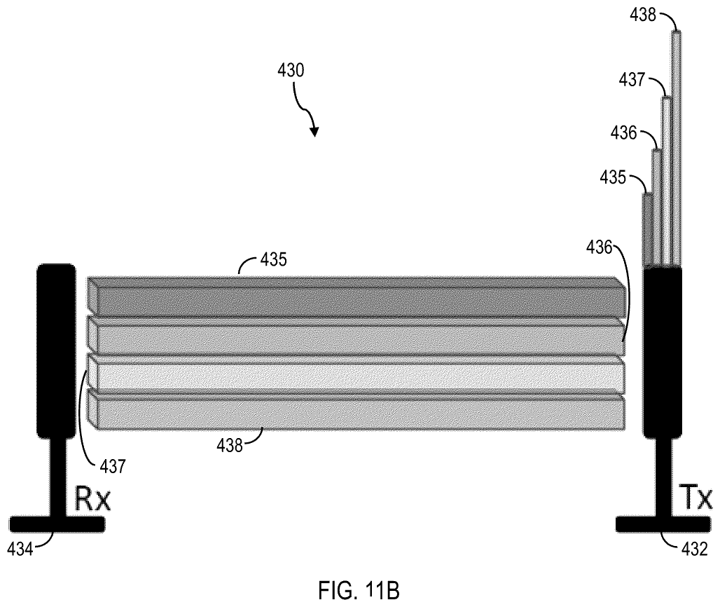

Referring to FIG. 11A, shown therein is a diagram of a multi-domain traffic management transceiver structure 420, according to an embodiment. The transceiver structure 420 includes a pair of transceivers 422a, 422b separated by a distance. Each transceiver 422a, 422b may be disposed on separate deployable, reusable autonomous vehicles. According to other embodiments, one transceiver 422a may be disposed on a building or structure on the ground and the second transceiver 422b may be disposed on an autonomous vehicle.

Each transceiver 422a, 422b can transmit and receive multiple bands of electromagnetic radiation 424, 426. Generally, the bands 424, 426 may comprise any wavelength of electromagnetic radiation, e.g., microwaves, visible light, etc. A separate volume of space 428, 429 between the transceivers 422a, 422b, is reserved for each band 424, 426. When the transceivers 422a, 442b are appropriately oriented, beamforming of the bands 424, 426 is achieved.

Using digital beamforming, the volumes of space 428, 429 can be configured to be very tight and close to each other. Each volume of space 428, 429 can be considered a “smart space” (i.e., volume) for performing designated tasks. For example, a first volume 428 having the first band 424 of EM radiation may be used as an operational zone for point-to-point beam riding highway by drones between the transceivers 422a, 422b; a second volume of space 429 having the second band 426 of EM radiation may be used as a designated recharging zone.

Referring to FIG. 11B, shown therein is a diagram of a deployable smart space system 430, according to an embodiment. The smart space system 430 includes a transmitter 432 and a receiver 434. According to other embodiments, two transceivers may be used. The transmitter 432 broadcasts multiple bands 435, 436, 437, 438 of EM radiation, each band 435, 436, 437, 438 defining a smart space. The transmitter 432 may be configured for 360 beam steering, to direct the bands 435, 436, 437, 438 in any direction, as needed. However, for a smart space to be formed, the transmitter 432 and the receiver 434 must be properly oriented for the smart space to be formed therebetween.

The smart spaces defined by the bands 435, 436, 437, 438 are typically invisible to the naked eye, but may be visualized with augmented reality equipment to “see” the smart spaces. For example, each band may be designated by a visible color in augmented reality. Accordingly, there may be numerous applications for smart spaces in planning and logistics for setting up autonomous vehicle systems as well as for power generation, distribution and storage. The smart space system 430 could be combined with an advanced metering interface to manage private/public use cases and applications. The smart space system 430 may be integrated with AI/ML algorithms to manage operations, logistics and maintenance of autonomous vehicle systems/networks.

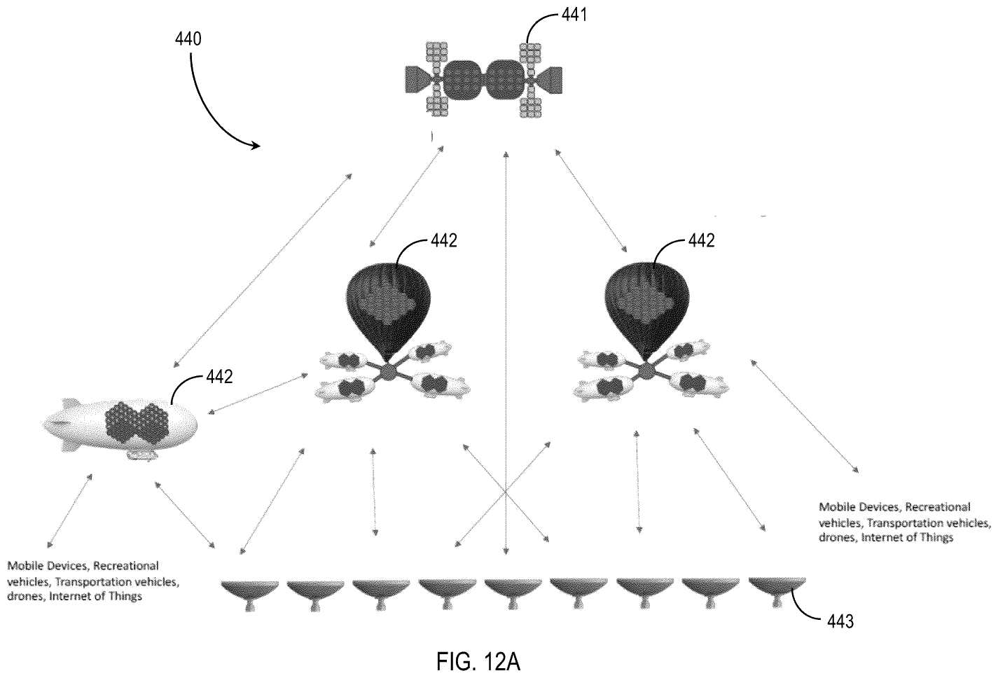

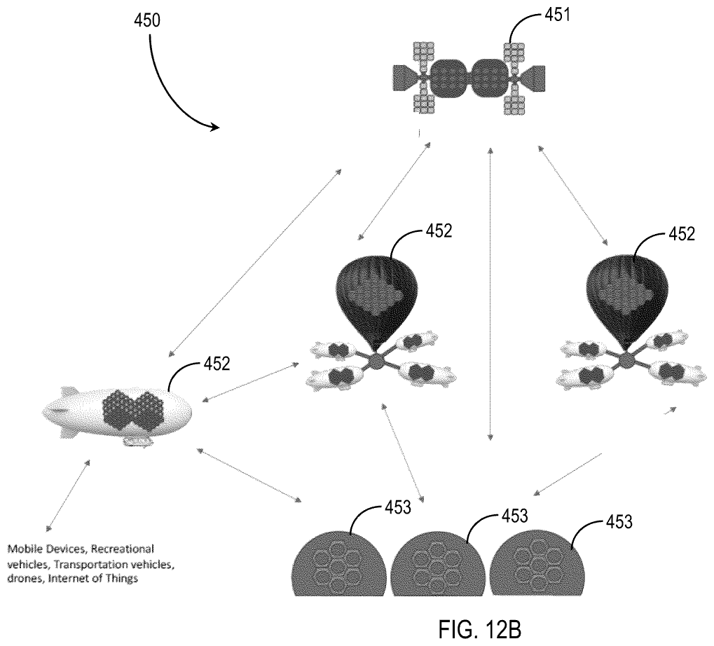

Referring to FIG. 12A shown therein is a diagram of a deployable data hub system 440 for use in point-to-point data transmission, according to an embodiment. The system 440 includes a constellation of satellites 441, a fleet of aerial craft 442 and ground stations 443. The satellites 441 include a thermal power generation system to combust fuel for propulsion and provide energy to power onboard systems.

In conventional systems wherein data is beamed directly from satellites 441 to ground stations 443, the satellite 441 must be in range (i.e., above the ground station 443) for successful data transmission. Compared to conventional systems, the system 440 is advantageous to provide an intermediary data hub in the fleet of aerial craft 442 to relay signals between the satellite 441 and the ground stations 443. Accordingly, a satellite 441 need not be in direct range of a ground station 443 for successful data transmission and may transmit or receive data via the aerial craft 442 data hub. A further advantage is that data received from the satellite 441 may be transmitted directly from the aerial craft 442 data hub to IoT devices (not shown) rather than having to pass through a ground station 833 first.

Referring to FIG. 12B, shown therein is a diagram of a rapidly deployable power hub system 450 for use in point-to-point wireless power transmission, according to an embodiment. The system 450 includes a constellation of satellites 451, a fleet of aerial craft 452 and deployable ground stations 453. The satellites 451 may include a thermal power generation system to combust fuel for propulsion and provide energy to power onboard systems. The satellites 451 may include solar cells for harvesting solar energy for powering onboard systems. The satellites 841 include transmitters to beam EM radiation down toward the earth from the power generated by the satellite 451. The fleet of aerial craft 452 are positioned or tethered at an intermediate altitude between the satellite 451 and ground stations 453. The aerial craft 452 include arrays of EM radiation transmitters and receivers (including rectennas). The aerial craft 452 receive the radiation beamed down from the satellite 841 and retransmit the radiation downward toward the earth.

The deployable ground stations 453 may be additively manufactured, deployable structures to house personnel, and other materials. The deployable ground stations 453 include arrays of rectennas to collect the radiation beamed downward from the aerial craft 452. The deployable ground stations 453 are preferable dome shaped to provide maximal area for deployment of the arrays of rectennas to receive beamed radiation from the aerial craft. The system 450 may be advantageously used to generate power in remote areas where power availability is low or when a local electrical grid is down. Alternatively, the system 450 may be used to augment available energy.

The rapidly deployable systems shown in FIGS. 12A-12B can serve as mobile power hubs for power generation, distribution and storage as well as mobile communications hubs all in one. It should be noted that the systems shown in FIGS. 12A-12B may be implemented for ground-to-space or space-to-ground power and data transmission on any planetary or astronomical body of sufficient size, including, but not limited to the Earth, the Moon, Mars, and asteroids.

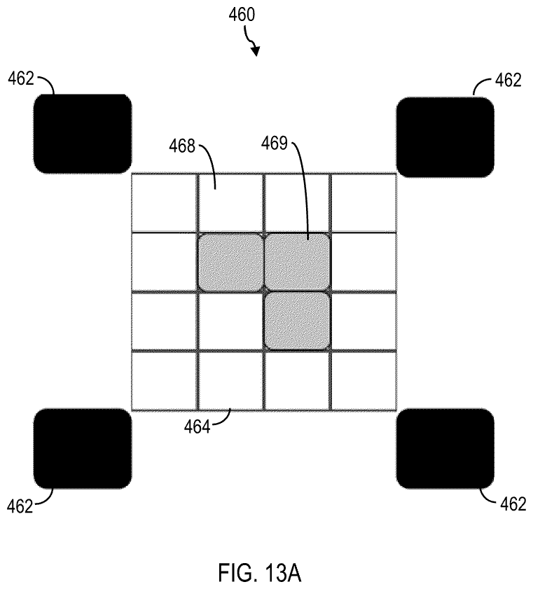

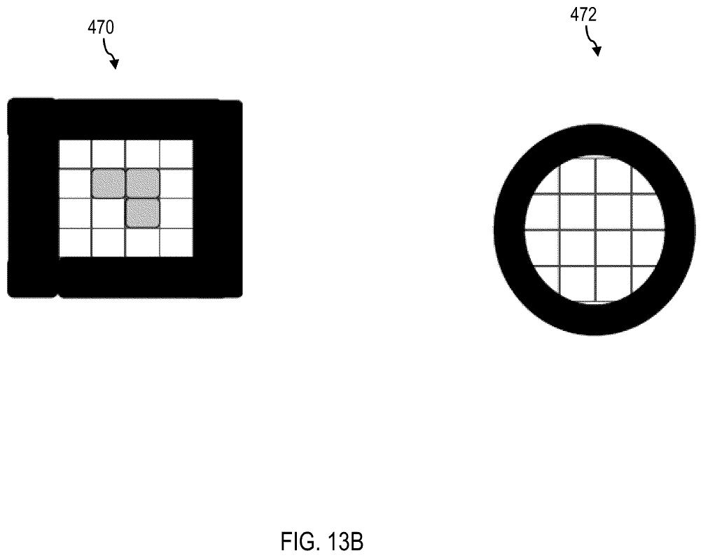

Referring to FIG. 13A, shown therein is a diagram of a deployment mesh system 460 for a deploying wireless power and data distribution networks, according to an embodiment. The mesh system 460 may be used for the deployment, positioning and station keeping of satellites in space, or UAVs in atmosphere.

The mesh system 460 includes a flexible mesh structure 464. The mesh structure 464 can generally be in any shape. When deployed, the mesh structure 464 forms a grid-like scaffold 468, for positioning satellites 469 or UAVs thereon or therebetween. The mesh structure 464 is integrated with a power and/or data distribution interface including, for example, power cables, fibre links, or waveguides, connecting the satellites 469 or UAVs.

The mesh system 460 includes deployable autonomous vehicles 462 e.g., satellites or airships, that transport the mesh system 460 to a position for deployment, and hold the scaffold 468 in its shape when deployed. The autonomous vehicles 462 may be inflatable and/or additively manufactured. Generally, the autonomous vehicles 462 are positioned around the periphery of the mesh structure 464.

FIG. 13B shows deployment mesh systems 470, 472, according to other embodiments.

### Multi-Domain Autonomous Vehicle Networks

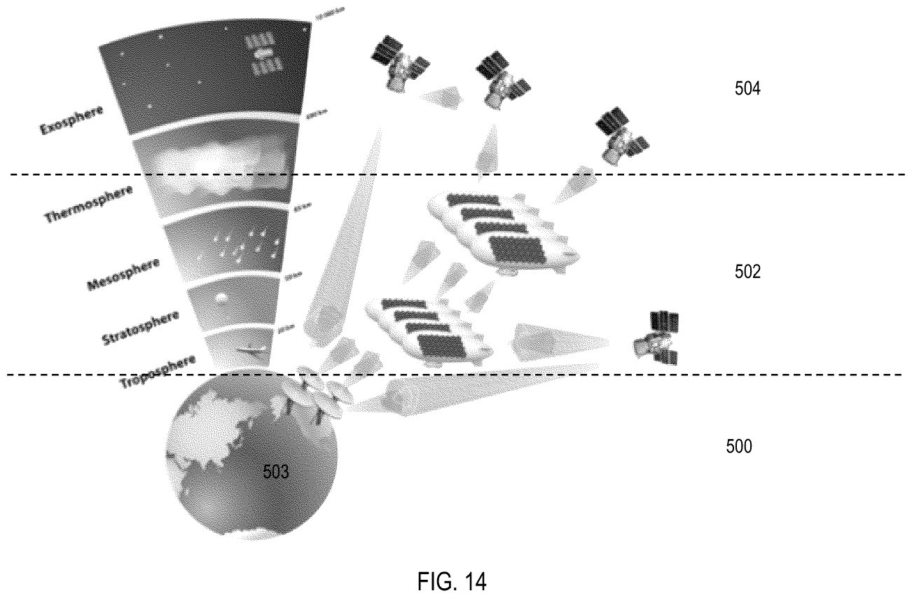

Referring to FIG. 14, the deployable, reusable autonomous vehicles systems/networks described herein can be deployed across multiple domains 500, 501, 502, 503 (i.e., water-ground-air-space) for power and data transmission across multiple domains. Power and data beaming to and from and between domains 500, 501, 502, 503 may be utilized to connect people and systems operating in multiple domains to provide situational awareness and rapid response across all or multiple domains 500, 501, 502, 503.

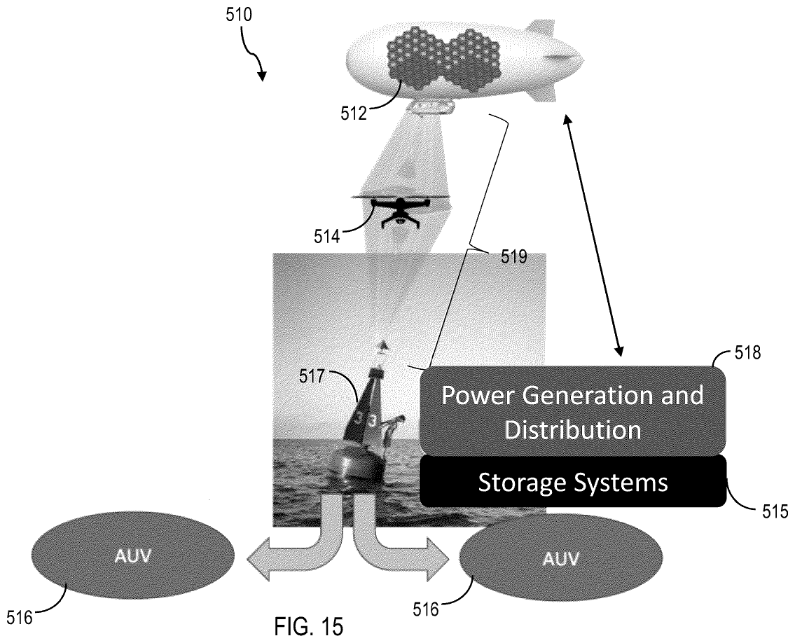

Referring to FIG. 15, shown therein is a diagram of an air-to-water system 510 for wireless power transmission, according to an embodiment. The system 510 includes an airship 512 having a transmitter to beam radiation downward. The system 510 includes a buoy 517 on the surface of a body of water.

The buoy 517 includes a power distribution system 518 (e.g., rectennas for receiving the radiation beamed from the airship 512) to create a beam riding highway 519 between the airship 512 and the buoy 517. The beam riding highway 519 may be used to transport drones 514 between the airship 512 and the buoy 517. Radiation in the beam 519 may also be received by power distribution system 518 on the buoy 517 and converted to electricity. The electricity may be stored in a storage system 515. The power generation system 518 and the storage system 515 on the buoy 517 may be deployable, inflatable and additively manufactured.

The buoy 517 may be configured as a charging station to store power generated by power generation system 518. The buoy 517 may include underwater architecture (not shown) to support the charging of multiple underwater vehicles 516.

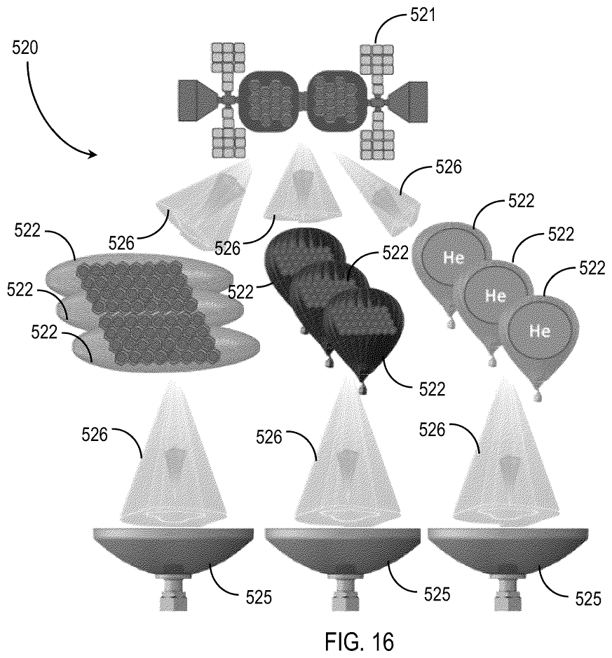

Referring to FIG. 16, shown therein is a diagram of a space-to-earth wireless power and data transmission system 520, according to an embodiment. The system 520 includes one or more satellites 521 in orbit. The satellites 521 include arrays of solar cells to receive solar radiation and generate power. The satellites 811 may include a thermal power generation system to combust fuel for propulsion and provide energy to power onboard systems.

The satellites 521 include transmitters to beam EM radiation 526 down toward the earth from the power generated by the solar cells. The system 520 includes one or more aerial craft 522 positioned at an intermediate altitude. The aerial craft 522 include arrays of EM radiation transmitters and receivers (including rectennas). The aerial craft 522 receive the radiation 526 beamed down from the satellite 521 and retransmit the radiation 526 downward toward the earth. The system 520 includes ground-based parabolic receivers 525 to collect the EM radiation 526 beamed down from the aerial craft 522. The parabolic receivers 525 may include rectenna arrays to convert the received radiation 526 to electricity for use on the ground.

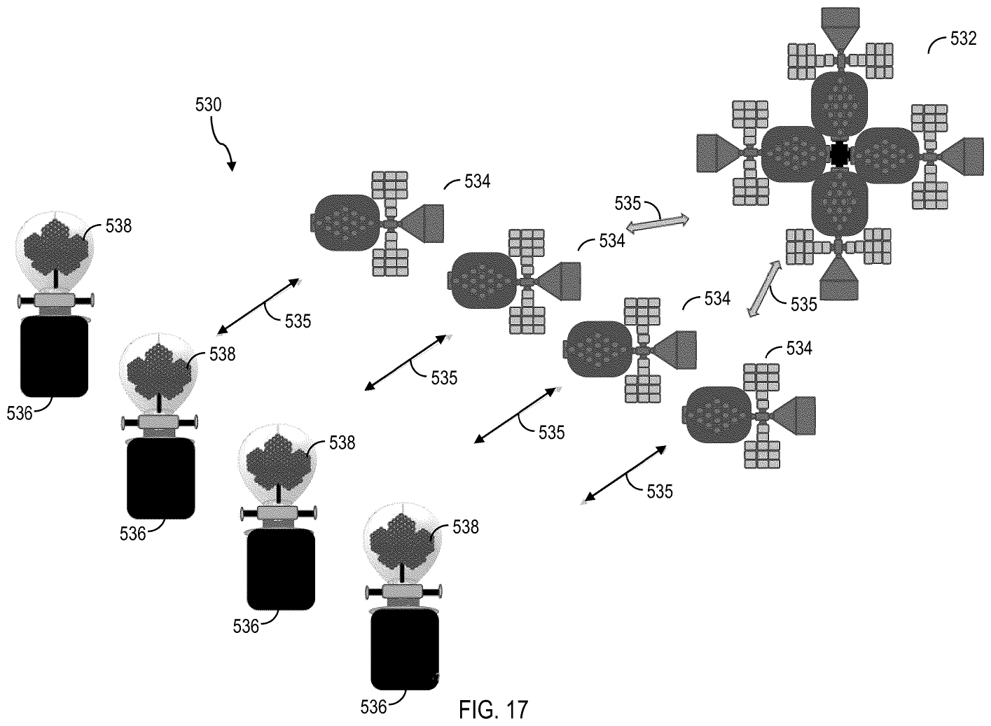

Referring to FIG. 17, shown therein is a diagram of a space-to-air wireless power and data transmission system 530, according to an embodiment. The system 530 includes a plurality of satellites 532, 534 in orbit. Some satellites 532 may be in far earth orbit. Some satellites 524 may be in near earth orbit. The satellites 532, 534 include arrays of solar cells to receive solar radiation and generate power. The satellites 523, 534 may include a thermal power generation system to combust fuel for propulsion and provide energy to power onboard systems.

The satellites 532, 534 include transmitters to beam EM radiation 535 down into the atmosphere from the power generated by the solar cells and/or thermal power plant. The system 530 includes one or more aerial craft 536 positioned in the atmosphere. The aerial craft 536 include arrays of EM radiation receivers (including rectennas) for converting the radiation 535 beamed down from the satellites 532, 534 into electricity to power on-board systems, or store electricity for later retransmission.

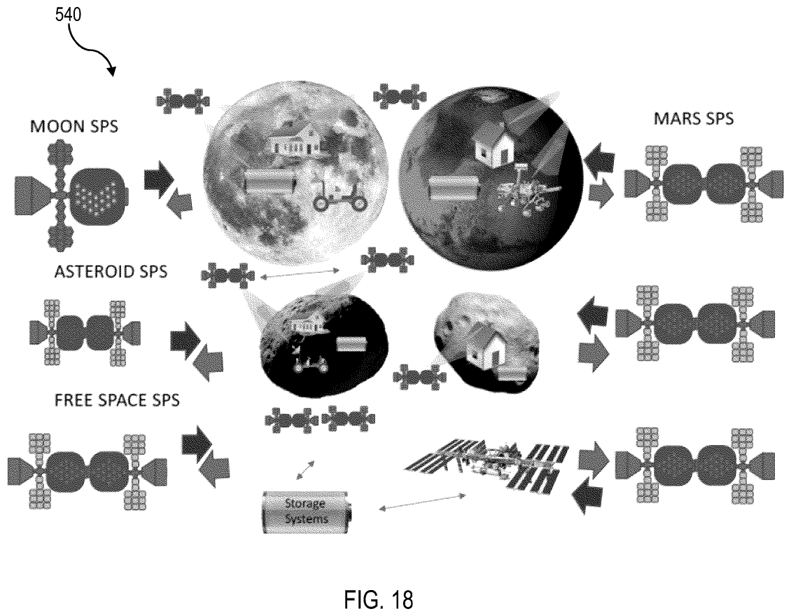

Referring to FIG. 18, shown therein is a diagram of in-space systems 540 for wireless power and data transmission, according to several embodiments. In-space systems 540 for wireless power and data transmission may be configured for directing power and data for control of in-space systems, constellation of satellites in orbit and surface operations of moon bases, rovers, drones, exploration vehicles and other lunar structures, and space architecture. The in-space systems 540 may be used to create a point-to-point network for wireless power and data transfer on bodies such as the Moon, Mars, asteroids, and Earth. Bodies may be orbited by a craft, such as a satellite that may communicate with devices or ground stations present on the surface of each body, such as to enable a large-scale wireless power and data transfer network, accessible on the surface and in the orbit of each body.

The power generated by and transmitted between in-space systems 540 may support remote operations far from Earth, for example, on planetary bodies, asteroid and generally harsh or extreme environments in space. In-space systems 540 may be used to relay and transmit power to enable travel and transport of material across vast distances, for example between Earth and Mars, using fleets of satellites or spacecraft positioned at waypoints between Earth and Mars. In-space systems are particularly suited to being inflatable and deployable, to save space on launch craft when transporting such systems into orbit. In-space systems 540 are also particularly suited to additive manufacturing using materials harvested in space.

Referring to FIG. 19, shown therein is a diagram of command and control of autonomous or semi-autonomous vehicle systems/networks, according to an embodiment. Extended reality (mixed/augmented/virtual reality) systems 550 are used to control fixed or mobile Earth autonomous vehicle systems 552 and fixed or mobile space autonomous vehicle systems 554. Extended reality systems 550 are advantageous for a single operator to control a fleet of autonomous vehicles from a safe location. For example, an operator on Earth may control space autonomous vehicle systems 554 by using an extended reality system 550. Extended reality systems 550 may also be the only way by which an operator can control space autonomous vehicles systems 554 that are operating in harsh or extreme conditions where a spacesuit will not provide sufficient protection for a human operator. Extended reality systems 550 may be coupled with haptic feedback mechanisms and AI/ML to allow the used to “see” and “feel” what sensors on autonomous vehicle systems 552, 554 detect. Extended reality systems 550 can be used as simulators for training, scenario-based learning, and evaluation purposes.

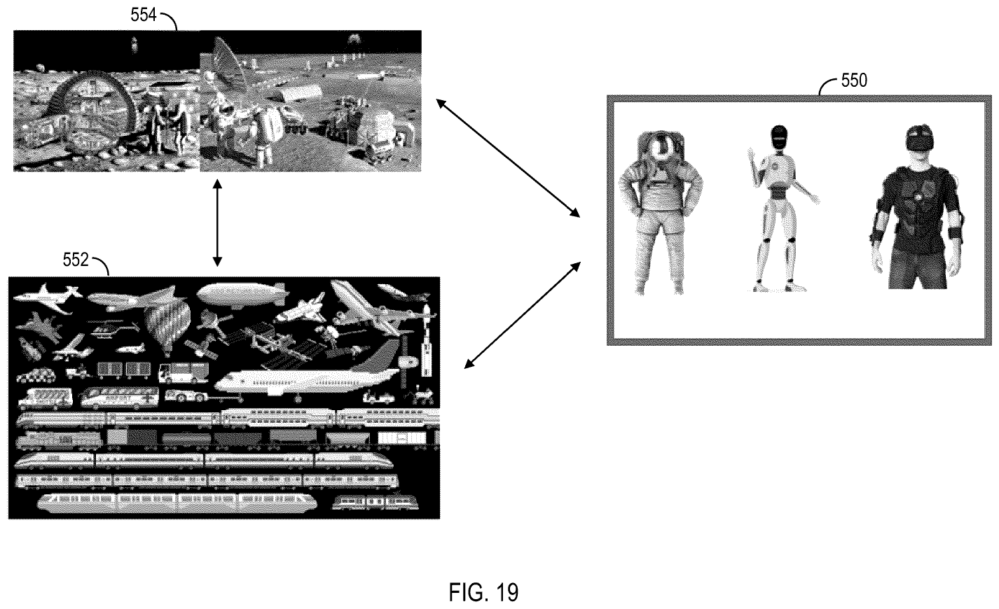

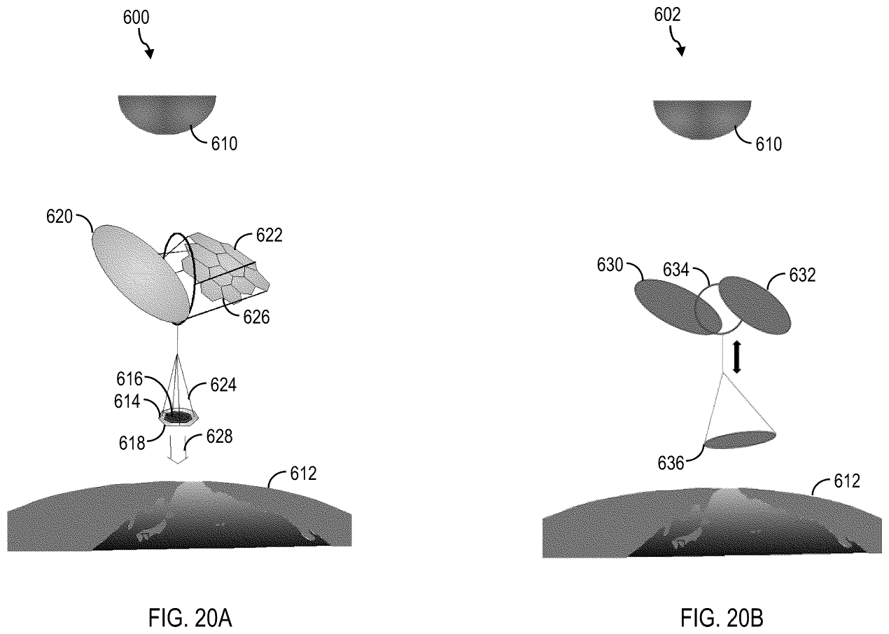

Referring to FIG. 20A, shown therein is a solar power satellite (SPS) sandwich module 600, according to an embodiment. The SPS sandwich module 600 is positioned in orbit above the Earth 612 to capture solar radiation and radiant heat from the sun 610 and converts it to usable energy. The SPS sandwich module includes a sandwich structure 614. The sandwich structure 614 is inflatable, deployable and has a similar construction as the sandwich satellite module 260 shown in FIGS. 8A and 8B. The sandwich structure 614 includes solar cells 616 on a top side and a transmitter 618 on a bottom side. The sandwich structure 614 is attached to a pair of reflectors 620, 622 by a cable 624.

The first reflector 620 concentrates solar radiation onto the second reflector 622. The angle of the first reflector 620 with respect to the second reflector 622 may be varied to regulate the how much radiation is directed onto the second reflector 622 to prevent overheating and damage. The second reflector 622 directs/concentrates light from the first reflector 620 onto the solar cells 616 on the sandwich structure 614. The angle of the second reflector 620 with respect to the solar cells 616 may be varied to regulate the how much light is directed onto the solar cells 616.

The second reflector 622 further includes thermophotovoltaic (TPV) cells 626 on a back side for converting radiant heat from the sun 610 into electricity. The electricity generated by the TPV cells 626 is carried by the cable 624 to the sandwich structure 614 for storage and/or retransmission as microwaves 628.

The reflectors 620, 622, are inflatable, deployable and are constructed of meta-materials suited to reflecting sunlight. For example, inflatable, deployable and/or additively manufactured surfaces/volumes are used to create the reflectors 620, 622 in space. In-situ resource utilization may be used to produce the SPS sandwich module 600 components in space e.g., using lunar regolith.

A mixture or slurry may be sprayed by another satellite or robot onto an inflatable/deployable structure to change the properties (mechanical, electrical, chemical, magnetic, etc.) of a surface of the structure to be reflective to radiation from the sun 610. One or more layers may be applied. According to other embodiments a liquid may be applied to the surface to form a liquid mirror using surface tension of the structure to move the liquid on the surface. A current or a conductive fluid is applied to change the surface tension of the structure and/or a magnetic field is applied to position the liquid on the surface. The magnetic field may be created by magnets, electromagnets arranged in various configurations (e.g., Halbach arrays)

Referring to FIG. 20B, shown therein is a diagram of SPS sandwich module 602, according to an embodiment. The SPS sandwich module 602 includes a reflector 630, a condensing system 634 and a sandwich receiver 632. The condensing system 634 includes a filter for regulating the amount of solar radiation and or the frequency that reaches the receiver 632 to optimize performance and prevent overheating and damage. The sandwich receiver 632 includes a receiver on a first side for collecting solar radiation. The sandwich receiver 632 includes photovoltaic cells or thermophotovoltaic cells or a combination thereof on a second side for converting sunlight and/or radiant heat into useable energy. The SPS sandwich module 602 includes a transmitter and storage module 636 for storing the energy received/converted by the sandwich receiver 632.

Referring to FIG. 20C, shown therein is a diagram of a SPS sandwich module 604, according to an embodiment. The SPS sandwich module 604, includes a pair of sandwich panels 640. Each sandwich panel 640 includes photovoltaic cells or thermophotovoltaic cells or a combination thereof on a first side and a transmitter on a second side. Instead of sending power to the ground, the SPS sandwich module collects solar radiation and/or radiant heat and transmits the energy as electromagnetic radiation 644 to a receiver and storage module 642 through wireless energy transfer.

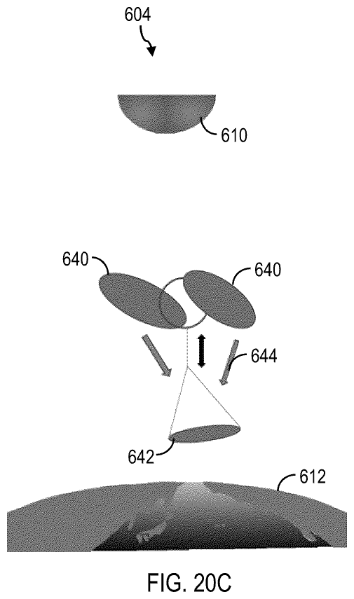

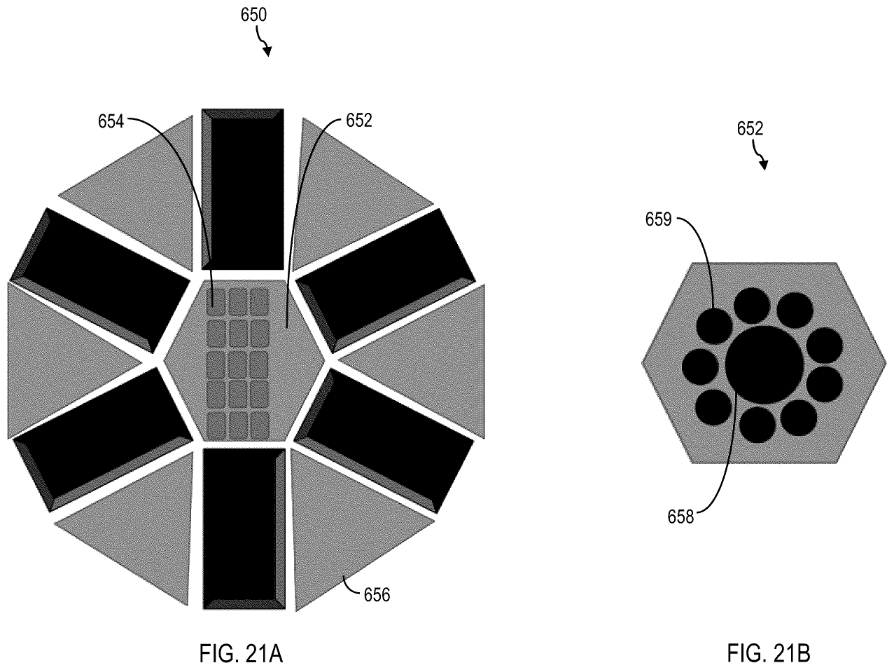

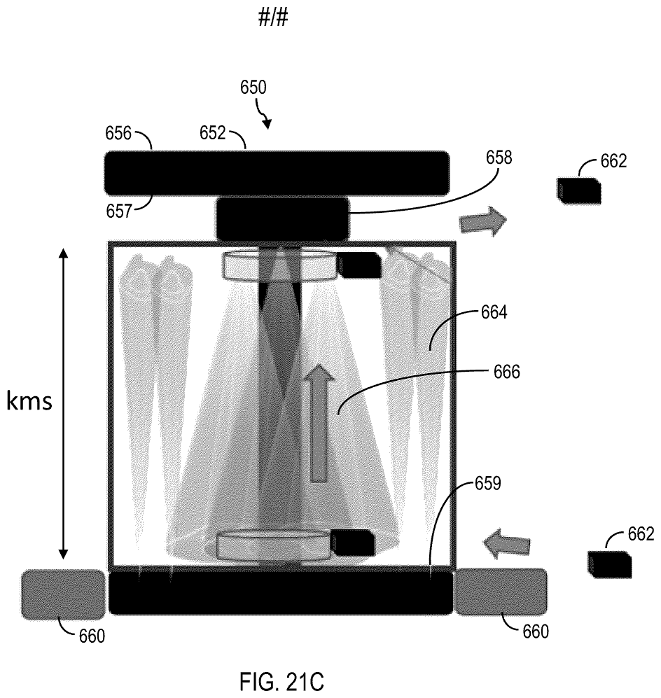

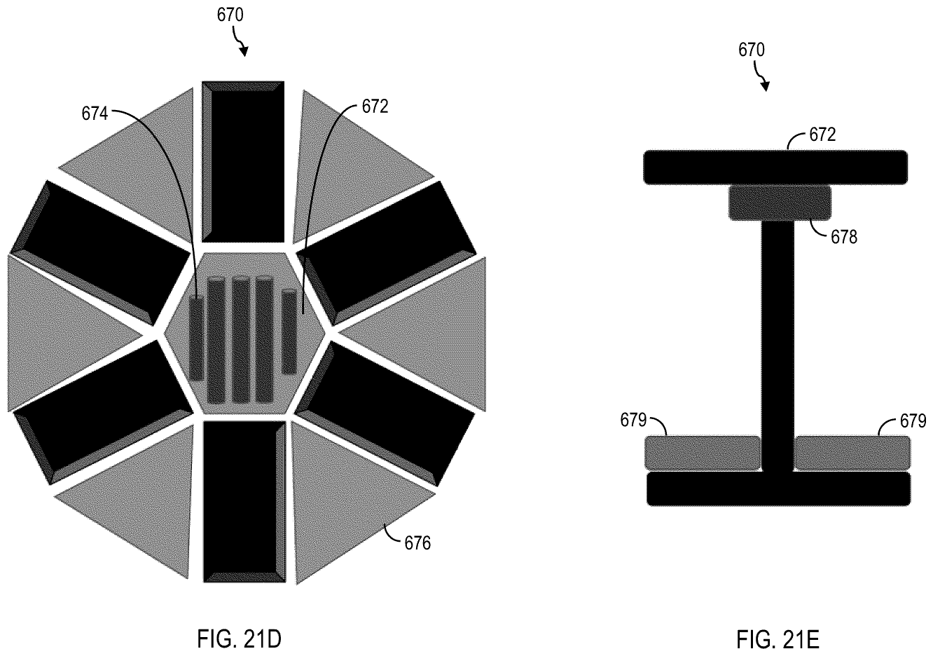

Referring to FIG. 21A, shown therein is a diagram of a top view of a SPS sandwich module 650, according to an embodiment. The SPS sandwich module 650 is gravity stabilized and used for orbit raising, beam riding and or in-flight charging of other satellites. The SPS sandwich module 650 includes a sandwich panel 652. The sandwich panel 652 includes a plurality of solar cells 654 (either photovoltaic cells or thermophotovoltaic cells or a combination thereof) for collecting solar radiation and/or radiant heat. The other side (not shown) of the sandwich panel 652 includes transceivers for beaming radiation for forming beam riding highways. The sandwich panel 652 is surrounded by reflectors 656 to concentrate and direct the solar radiation onto the solar cells 654. Each reflector is independent of the others. As the SPS sandwich module 650 orbits the Earth, the reflectors 656 can be oriented independently to concentrate solar radiation onto the solar cells 654.

Referring to FIG. 21B, shown therein is a diagram of a bottom side of the sandwich panel 652. The bottom of the sandwich panel 652 includes transceivers 658, 659 for forming beam riding highways. The transceivers 659, 659 are arranged in a ring to form multiple beam riding highways i.e., smart spaces.

Referring to FIG. 21C shown therein is a diagram of a side view of the SPS sandwich module 650. The SPS sandwich module 650 includes storage units 660 for storing the power generated by the solar cells. The SPS sandwich module includes receivers 657 on the bottom side of the reflectors 656. The receivers 657 and transceivers 658, 659 are used to beamform beam riding highways 664, 666, i.e., smart spaces. A central beam riding highway 666 is used for orbit raising by beam riding. A satellite 662 can enter the bottom of the beam riding highway 666, travel up to a higher orbit and exit the beam riding highway 666. The peripheral smart spaces 664 may be used for in-flight charging of the satellite 662 while it is being raised.

Referring to FIG. 21D, shown therein is a diagram of a top view of a SPS sandwich module 670, according to an embodiment. The SPS sandwich module 670 is used for in space power generation. The SPS sandwich module 670 includes a sandwich panel 672 having a plurality of thermophotovoltaics cells 674. The carbon nanotubes 674 contain a working fluid in a closed-loop heat exchange power generation system. The sandwich panel 672 is surrounded by reflectors 676 to concentrate and direct the radiant heat onto the thermophotovoltaics cells 674.

Referring to FIG. 21E, shown therein is a diagram of a side view of the SPS sandwich module 670. The SPS sandwich module 670 includes a closed-loop heat exchange system 678 for converting the heat in the working fluid to usable energy. The energy may be stored in storage modules 679 or may be beamed by wireless energy transfer to another point.

While the above description provides examples of one or more apparatus, methods, or systems, it will be appreciated that other apparatus, methods, or systems may be within the scope of the claims as interpreted by one of skill in the art.

What is claimed is systems and methods as generally and as specifically described herein.

1. An autonomous vehicle platform for relaying electromagnetic radiation, comprising:
a hybrid propulsion system comprising:
at least one rotor/propeller; and
at least one inflatable balloon system,
a first antenna for transmitting electromagnetic radiation in one or more bands; and
a docking interface configured for docking with at least one other autonomous vehicle.

2. The autonomous vehicle platform of claim 1, wherein the first antenna comprises:
active phased array for digital beamforming of the one or more bands.

3. The autonomous vehicle platform of claim 1, further comprising:
a second antenna for receiving the electromagnetic radiation in one or more bands.

4. The autonomous vehicle platform of claim 3, wherein the second antenna comprises:
an active phased array for digital beamforming of the one or more bands.

5. The autonomous vehicle platform of claim 3, wherein the second antenna comprises:
a 3D active phased array for digital beamforming of the one or more bands.

6. The autonomous vehicle platform of claim 3, wherein the first antenna and the second antenna are in a transceiver.

7. The autonomous vehicle platform of claim 3, further comprising:
a deployable structure having at least one of the first antenna and the second antenna disposed thereon.

8. The autonomous vehicle platform of claim 1, further comprising:
a deployable structure having the docking interface disposed thereon.

9. The autonomous vehicle platform of claim 1, wherein the docking interface includes a magnetic and/or electromagnetic coupling.

10. The autonomous vehicle platform of claim 1 further comprising:
a plurality of rectennas on a surface of autonomous vehicle platform for receiving electromagnetic radiation in one or more bands.

11. The autonomous vehicle platform of claim 9 further comprising:
a deployable structure having the surface thereon.

12. A solar power satellite sandwich module, comprising:
a first surface having a plurality of solar cells disposed thereon; and
a second surface having at least one of a transmitter and a receiver disposed thereon, wherein the first surface and the second surface are opposed surfaces of a deployable structure.

13. The solar power satellite sandwich module of claim 11, wherein the solar cells comprise:
photovoltaic cells, thermophotovoltaic cells, or a combination thereof.

14. The solar power satellite sandwich module of claim 11, further comprising:
at least one docking interface configured for docking with at least one of:
another satellite and a deployable scaffold.

15. The solar power satellite sandwich module of claim 11, further comprising:
at least one deployable reflector for concentration and directing solar radiation and/or radiant heat onto the plurality of solar cells.

16. The solar power satellite sandwich module of claim 15, further comprising a filter for regulating the amount of solar radiation and/or radiant heat directed to the plurality of solar cells.

17. The solar power satellite sandwich module of claim 11, wherein the transmitter comprises:
an active phased array for transmitting electromagnetic radiation in one or more bands.

18. The solar power satellite sandwich module of claim 11, wherein the receiver comprises:
an active phased array for receiving electromagnetic radiation in one or more bands.

19. The solar power satellite sandwich module of claim 11, wherein the transmitter and the second receiver are in a transceiver.

20. The solar power satellite sandwich module of claim 11, further comprising a plurality of rectennas on a surface of the satellite for receiving electromagnetic radiation in one or more bands.

21. The solar power satellite sandwich module of claim 11, further comprising a storage system for storing the energy generated by the plurality of solar cells and/or the plurality of rectennas.

22. A deployment mesh system for positioning autonomous vehicles, comprising:
a deployable mesh structure for forming a scaffold to attach autonomous vehicles thereto;
a power and data distribution interface integrated to the deployable mesh structure for transmitting power and data between the autonomous vehicles; and
a plurality of autonomous vehicles for deploying, positioning and holding the mesh structure in the atmosphere or in space or other domains.

23. A deployable network for wireless power distribution across at least two domains, comprising:
a first autonomous vehicle in a first domain; and
at least a second autonomous vehicle in a second domain,
each autonomous vehicles comprising:
a propulsion system for positioning the autonomous vehicle in the domain and moving between domains;
a wireless power transfer system, comprising:
a transmitter for transmitting electromagnetic radiation in at least one band; and
a receiver for receiving the electromagnetic radiation in the at least one band.
